(19) United States
(12) Patent Application Publication
(10) Pub. No.: US 2024/0233007 A1
(43) Pub. Date: Jul. 11, 2024

(54) SYSTEM AND METHOD FOR IMPROVED EXCEPTION HANDLING BY A PAYMENT PLATFORM

(71) Applicant: Global Holdings LLC, Tulsa, OK (US)

(72) Inventor: Christopher Wayne Woodard, Tulsa, OK (US)

(21) Appl. No.: 18/454,533

(22) Filed: Aug. 23, 2023

Related U.S. Application Data
(63) Continuation of application No. 17/373,086, filed on Jul. 12, 2021, now abandoned.

(51) Int. Cl. G06Q 40/02; G06F 16/23; G06F 16/245; G06Q 20/02; G06Q 20/04; G06Q 40/12

(52) U.S. Cl. CPC G06Q 40/02; G06F 16/2365; G06F 16/245; G06Q 20/023; G06Q 20/042; G06Q 40/12

(57) ABSTRACT

In an illustrative embodiment, systems and methods by which a payment system may respond to its failure to identify an association between a payment record and an item record include recording exception type information describing a potential reason for the failure of such association to be identified. An item record may record information about an electronic payment instrument initiated by a third party, by which funds were transferred from a disbursement account maintained by an operator of the payment system to the aforementioned third party. A payment record may record information concerning a payment scheduled to be initiated by the payment system. In response to such a failure, a potential association between the aforementioned item record and a payment record may be recorded. Information from the item record, along with the exception type information, are exposed to a network via an application interface.

### RELATED APPLICATIONS

This application is a continuation of U.S. patent application Ser. No. 17/373,086, filed Jul. 12, 2021, the disclosure of which is hereby incorporated by reference.

### TECHNICAL FIELD

Herein is disclosed a system and method for improved exception handling by a payment platform, and more particularly a system method to categorize, make available via a network, and associate with potential remedial steps, exception events that arise from the inability of a matching process executed by a payment platform to properly identify an association between a scheduled payment and an item in a bank file by which the scheduled payment was effectuated.

### BACKGROUND

In the field of electronic funds disbursement, it is common for a party to send money to an intermediary such as a payment processor for the purpose of funding one or more subsequent disbursements of funds. For example, a debt settlement payment processor may serve as an intermediary to disburse funds received by a client desiring to settle certain debts, such as credit card debts, pursuant to an arrangement typically secured by a debt settlement company on behalf of the client. Such an arrangement typically calls for the client's creditors to be paid certain sums pursuant to certain terms and for other parties, such as the debt settlement company, to also be compensated out of the client's funds. In such circumstances, the client may send funds to the processor for the processor to disburse in accord with the aforementioned arrangement.

Continuing on with the example of a debt settlement payment processor, the creditors to which the funds are disbursed may receive their funds via a diversity of mechanisms. For example, the debt settlement payment processor may produce a physical check representing each payment to be made on behalf of a given client to a given creditor, and such check may be couriered to the client's creditor. As another example, the payment processor may arrange for the initiation of a wire transfer to effectuate each such payment to each such creditor.

In the preceding examples, the payment processor initiated the payment mechanism by which the creditor received its funds. As a consequence of initiating the payment mechanism, the payment processor is readily able to relate a particular payment instrument (such as a particular check) to an identifier (such as a key or other reference) used to identify a payment record in a database or data store maintained by the payment processor to record the various payment transactions conducted by the platform. The ability to relate a particular payment instrument to a payment record identifier within the payment processor's database may be important for many reasons. For example, in the case of a debt settlement payment processor, the payment processor may be called upon to provide a debt settlement company with a report that proves that a given creditor of one of the clients of the debt settlement company actually received all of the payments required of a given client to settle the client's debt. Such a report would present each payment instrument by which the payment processor conveyed sums to the creditor (example: the report would present, in the case wherein the payment instruments were checks, each check sequence number by which the processor conveyed sums to the creditor, along with the payment amount associated with such sequence number, the date that each such check was cleared, and so on). In order to produce such a report, the relationship between an identifier of a given payment record within a payment processor's database and its properly corresponding payment instrument must be established correctly.

It may not always be the case that a disbursement event is initiated by the payment processor. For example, it may be the case that a given creditor initiates the disbursement event, such as by use of a remotely created check (RCC) or an automated clearinghouse (ACH) transaction that, when processed, moves funds from a bank account (which may be referred to as a “disbursement account”) maintained on behalf of the payment processor to a financial account of the creditor. In other words, a creditor may “pull” funds from a disbursement account, as opposed to relying upon the payment processor to “push” the funds (via a check, wire, etc.) from the disbursement account. Under such a circumstance, the payment processor is informed of each such disbursement event by an entry in a computer file provided by the payment processor's bank. Each such entry may be referred to as an “item” or “bank item.” Each item identifies an ACH transaction or remotely created check transaction that caused a disbursement of funds from a disbursement account.

A payment processor must match each bank item with a payment transaction record stored in a data store maintained by the processor to create the aforementioned association. For example, such a payment transaction record may include information stating that on a given date, a given quantity of a certain client's funds was scheduled to be moved into a disbursement account to be paid to a given creditor as part of a regimen to settle a given debt. A payment processor much match a bank item to a payment transaction record of the sort just described, in order to show that a given ACH or remotely created check was the particular payment instrument that, in fact, was responsible for disbursing the funds from the disbursement account to the creditor.

The payment processor may attempt to match an item to an underlying payment transaction record via automated processes or via manual procedures carried out by personnel representing the payment processor. Sometimes the matching process fails to identify an underlying payment transaction record that corresponds to a given bank item. When such a failure occurs, the item may be identified by the payment processor as an exception.

It is usually the case that the payment processor is able to associate a given exception with a particular debt settlement company. In other words, while the payment processor may not be able to definitively match a bank item to a particular payment transaction record, the payment processor may, in fact, be able to determine that the bank item occurred as a result of a party having “pulled” funds from a pool of funds designated for disbursement to creditors that have settled with consumers represented by a particular debt settlement company. In such a case, the payment processor typically sends a report on a daily scheduled basis to each debt settlement company on whose behalf it processes payments, to alert each such company of exceptions associated with it. At this point, it becomes the job of the debt settlement company to match each particular exception with a particular payment transaction record representing a payment that was scheduled to have been made on behalf of one of its clients to settle a particular debt with a particular creditor. The debt settlement company may be able to match an item to a payment transaction record, although the payment processor could not. For example, the debt settlement company may interact with a particular creditor and conclude that the creditor mistakenly initiated a payment mechanism pulling, for example, $90.00 from a disbursement account as part of a settlement of a given debt of a given client, when it should have pulled $95.00. From the vantage of the payment processor, it can see that it moved $95.00 to a disbursement account for a given creditor to pull on a given date. But it is unable to identify an item wherein $95.00 was, in fact, pulled by the given creditor on the expected date. Therefore, the payment processor cannot declare a definitive match between the payment transaction record by which $95.00 was scheduled to have been moved to the disbursement account and a particular bank item by which $95.00 was “pulled” by the appropriate creditor. The debt settlement processor may use its relationship with the creditor to determine that a typographical error occurred during the creditor's creation of the payment instrument by which it pulled the funds, and may therefore be able to identify a match between the aforementioned bank item and payment transaction record.

If the debt settlement company is able to associate a given exception with a given payment transaction record, it must then provide instructions to the payment processor pertaining to how remediate the exception. This effort is laborious and requires precise instructions to the payment processor. Moreover, this effort is subject to time limitations. If, for example, it is determined by the debt settlement company that the exception relates to a “pull” of funds that simply should not have occurred, the payment processor will instruct its bank to initiate a return of the funds from the bank that received the funds. As time elapses, it may be the case that either the disbursed funds cannot be returned at all, or, if they can in fact be returned despite the elapsing of such time, the particular mechanism by which the return can be effectuated may result in scrutiny being brought to bear upon the particular creditor from which the funds were returned, which is a disruptive result. For all of these reasons, there exists a need for improvements to the systems used to surface and/or resolve exceptions.

### SUMMARY

Against this background, the present subject matter was developed. According to some embodiments, a payment system includes a data store, and the payment system is arranged to initiate a payment process upon an effective date and to a payment recipient. The effective date and the payment recipient are determined by effective date information and payment recipient information stored in a payment record that is stored in the data store. The payment process includes a funds transfer step that is not initiated by said payment system, and occurrence of the funds transfer step is recorded in an item record in the data store. The payment system includes a computing device that, in turn, includes a processing unit and a memory communicably connected with and readable by the processing unit. The memory unit containing instructions that, when executed by said processing unit, cause said processing unit to perform a matching process to attempt to identify an association between the payment record and the item record. The matching process records an exception record in the data store, in response to a failure of said matching process to identify said association. The exception record includes exception type information. Information from the item record and the exception type information from said exception record are exposed by a first application interface accessible via a network. A selected response code is received via a second application interface accessible via said network. The selected response code contains information sufficient to perform operations via the payment system that result in the association being identified.

According to other embodiments, herein is disclosed a method for responding to failure of a matching process, implemented by a payment system, to associate a payment record with an item record. The payment system initiates a payment process upon an effective date and to a payment recipient. The effective data and payment recipient are determined by effective date information and payment recipient information stored in the aforementioned payment record. The payment process includes a funds transfer step that is not initiated by the payment system, itself. Occurrence of the aforementioned funds transfer step is recorded in the aforementioned item record. The payment system performs the matching process in order to attempt to identify an association between said payment record and said item record. The matching process records an exception record, in response to a failure of the matching process to identify the aforementioned association. The exception record includes exception type information. The payment system exposes, via a first application interface accessible via a network, information from the item record, as well as the exception type information from the exception record. The payment system receives, via a second application interface accessible via said network, a selected response code. The selected response code contains information sufficient to perform operations via the payment system that result in the aforementioned association being identified.

According to other embodiments, herein is disclosed a method for responding to a failure of a matching process, implemented by a payment system, to associate a payment record with an item record. The payment system initiates a payment process upon an effective date and to a payment recipient. The effective data and payment recipient are determined by effective date information and payment recipient information stored in the aforementioned payment record. The payment process includes a funds transfer step that is not initiated by the payment system, itself. Occurrence of the aforementioned funds transfer step is recorded in the item record. The payment system performs the aforementioned matching process in order to attempt to identify an association between the payment record and the item record. The matching process records exception type information, in response to a failure of the matching process to identify the aforementioned association. The payment system exposes, via a first application interface accessible via a network, information from the item record, as well as the exception type information. The payment system receives, via a second application interface accessible via the aforementioned network, a selected response code. The selected response code contains information sufficient to perform operations via the payment system that result in the aforementioned association being identified.

### BRIEF DESCRIPTION OF THE DRAWINGS

FIG. 1 depicts an exemplary embodiment of a payment processing platform, in accordance with some embodiments.

FIG. 2 depicts a more detailed view of a payment processing platform, in accordance with some embodiments.

FIG. 3 depicts a software system implemented by the payment processor's computing platform, in accordance with some embodiments.

FIG. 4 depicts exemplary acts performed by the software system of FIG. 3, in accordance with some embodiments.

FIGS. 5A and 5B depict examples of user interfaces by which a representative of a debt settlement company could review a particular exception and provide feedback based upon his or her evaluation, in accordance with some embodiments.

FIG. 6 depicts exemplary endpoints exposed by the API layer of the software system of FIG. 3, in accordance with some embodiments.

FIG. 7 depicts exemplary embodiments of a method that may be executed by the system 338 in FIG. 3, in order to populate a data store that is part of the system 338, according to some embodiments.

FIG. 8 depicts exemplary embodiments of a method that may be executed by the system 338 in FIG. 3, during its use, according to some embodiments.

FIG. 9 depicts exemplary embodiments of a method that may be executed by the system 338 in FIG. 3, in order to store information pertaining to resolved exceptions, according to some embodiments.

FIG. 10 depicts other embodiments of the software system of FIG. 3, according to some embodiments.

FIG. 11 depicts a schematic illustration of embodiments of a computer system that can perform the methods provided by various other embodiments, as described herein, and/or can function as the backend computing computer platform or system, a server system, a laptop, tablet, smartphone, a mobile device, and/or a computer system.

### DETAILED DESCRIPTION

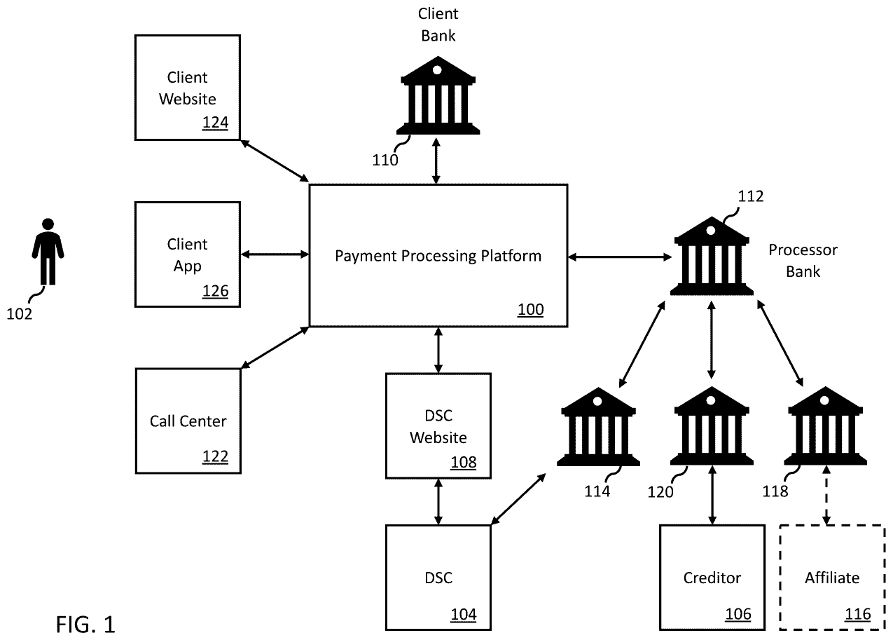

FIG. 1 depicts a payment processing platform 100 that may be accessed by a user 102 to make payments that involve disbursement of funds to multiple parties. Herein, the platform 100 is described in the context of debt settlement processing, but those of skill in the art will understand that it may be used in connection with payment processing generally. The platform 100 is of particular use in scenarios in which funds are to be disbursed to a party that intends to initiate the disbursement by “pulling” the funds from a disbursement account maintained by a payment processor, while at the same time imposing the requirement that each such disbursement event be matched to a payment record maintained in a data store by the payment processor. Debt settlement processing is one example of a funds disbursement scenario fitting the aforementioned description, and as such it is useful for illustration, but is nevertheless only exemplary.

In the context of debt settlement processing, an individual 102 engages a debt settlement company 104 to settle his outstanding debts with one or more creditors 106. For example, the user 102 may have one or more credit card debts that he is unable to pay, and to resolve the matter without bankruptcy, he may engage a debt settlement company 104 to negotiate on his behalf with the various issuers 106 of his credit cards. The debt settlement company 104 works with the issuers 106 to establish payment terms that will satisfy them, so that upon the user's 102 performance, the issuers 106 will consider the user's 102 debt repaid. Debt settlement companies 104 typically charge their clients 102 various fees (administrative fees, settlement fees, etc.), and the company 104 receives its payment out of the funds that the clients 102 transmit to the payment processor. In other words, those funds are used as the source of settlement payments to the credit card issuers 106 and fee remittances to both the companies 104 and the operator of the platform 100 (the payment processor). Debt settlement companies 104 may negotiate on behalf of individuals 102 to settle all manners of debts and need not function exclusively in the realm of credit card debt. For this reason,

FIG. 1 uses the term “creditor” 106, as this refers to all categories of entities that may have extended debt to a user 102 of the platform 100. To the extent this document refers to the creditor 106 as an issuer of a credit card, such reference is merely for the sake of illustration and conveys no limitation. Because the user 102 is a client of the debt settlement company 104 he will therefore often be referred to herein as a “client” 102. Although this document uses the terms “debt settlement company” or “company,” it is to be understood that many different varieties of entities may perform the function of negotiating debt settlements (example: a law firm), and these terms refer to all such entities. This document may also use the term debt settlement provider 104.

A debt settlement company 104 functions in cooperation with a debt settlement payment processor. It is the function of a debt settlement payment processor to receive transmissions of funds from clients 102, and to disburse those funds to creditors 106, debt settlement companies 104 and perhaps other interested parties. Such disbursement is to be conducted according to instructions given to it by the debt settlement companies 104 the payment processor services, and the instructions are assumed to comply with terms agreed upon between the debt settlement companies 104 and their various clients 102. The terms of such disbursements may also be constrained by various laws, both federal and state-by-state. The disbursement activity is conducted by a payment processing platform, such as the payment processing platform 100 depicted in FIG. 1.

Use of the platform 100 is typically initiated by the arrival at an agreement between a debt settlement company 104 and the operator of the platform 100 (i.e., a debt settlement payment processor), whereby the operator is to process payments made by the company's 104 clients 102. In the immediate wake of having come to such an agreement, representatives of the operator of the platform 100 will establish an entity account for such a company 104. Herein, an account that identifies an entity, such as a client 102, a debt settlement company 104, a creditor 106, or an affiliate 116 (not yet discussed) within the platform 100 may be referred to as an “entity account.” The data constituting an entity account may be stored in a data store of the platform 100, such as a database. An entity account for a client 102 may be referred to herein as a “client entity account,” and an entity account for a debt settlement company 104 may be referred to herein as a “company entity account,” and so on. The company entity account creation process includes identifying the company 104 (provide corporate name, address, contact information and so on) and identifying its employees who are to access the platform 100 on behalf of the company 104 (such employees are assigned user names, passwords, and access levels prescribing which particular actions any given employee may undertake via the platform 100). Additionally, information concerning the particular bank account into which the company's 104 fees should be settled is entered into the company entity account (example: a setup script may be run by personnel of the payment processor to introduce into the company's 104 entity account information such as the name of the financial institution 114 maintaining the company's 104 bank account, the account number associated with such account, routing number, SWIFT code, and so on, so that funds may be settled into the account).

After account creation, representatives of the debt settlement company 104 may access the platform 100. For example, the representatives may access a website 108 that is intended for use by debt settlement companies 104 desiring to interact with the platform 100. As a company 104 acquires clients 102, its personnel may use the platform 100 to conduct client entity account creation for each of its new clients 102. During client entity account creation for a new client 102, a company 104 representative may enter information identifying the new client (name, address, social security number, telephone number, bank account information, and so on). During this process, the representative may also enter information identifying each creditor 106 with which the company 104 has negotiated a debt settlement. If a particular creditor 106 of a new client 102 is a party to which the platform 100 has never disbursed funds, a creditor entity account is created for the creditor 106. In such a case, the representative may enter information identifying the creditor 106 (name, address, EIN, etc.) and a bank account into which the creditor's 106 payments are to be settled. According to some embodiments, a given creditor's 106 creditor entity account may be associated with no bank account information whatsoever, and that creditor 106 may receive payments initiated by the platform 100 that are of such a type that do not require knowledge of a bank account held by the creditor 106.

Associated with each client 102 account is a payment creation process. A representative of a debt settlement company 104 may initiate the process to define each payment to be made to a given client's 102 creditor 106 or creditors 106. The representative may enter information specifying the schedule of payments arising out of each negotiated settlement with each creditor 106, including payments to be made to each creditor 106 (amounts and dates), and, on a payment-by-payment basis, the disbursement method or payment instrument type by which the payment is to be made (physical check, wire, tracked check, and so on). Each such scheduled payment may be stored in a “Payments” table of a database, and may be identified by a key, referred to as a Payment_ID. The representative may also enter a schedule of fees owed to the debt settlement company 104 in compensation for its services (amounts and effective dates). Relatedly, the representative may also enter a schedule of dates on which the client 102 is to transmit certain funds to the processor (amounts and effective dates). Each such transmission of funds from the client's 102 account to the processor's aforementioned account may be referred to herein as a “draft.” The representative may schedule each draft, fee or creditor 106 payment throughout the entirety of a client's 102 debt settlement period, or may schedule them for a given client 102 on an ad hoc basis.

When a scheduled draft is initiated by the platform 100, the platform 100 instructs its banking partner 112 to initiate an automated clearing house (ACH) transaction in order to cause the client's 102 bank 110 to send the agreed upon draft amount to the payment processor's bank account. The payment processor typically holds a client's 102 funds in an aggregated custodial bank account along with funds from other clients 102. The funds held in the aggregated custodial account typically continue to be owned by a client 102 until such time as a scheduled payment is made to a creditor 106, or a fee is earned by and posted to a debt settlement company 104 or to the payment processor, itself. Payments to creditors 106 are conducted according to the payment type indicated during the creation of the particular scheduled payment being executed, as discussed above. Further details pertaining to creditor 106 payments are presented below.

As mentioned previously, it may be the case that other parties have a financial interest in a client's 102 draft sums. For example, a particular debt settlement company 104 may have relationships with one or more affiliates 116, whereby the affiliates 116 function as marketing arms for the debt settlement company 104 (or perform some other service to assist the debt settlement company 104). In such a scenario, each such affiliate 116 may have a claim upon a fraction of the fees that the debt settlement company 104 would otherwise enjoy an exclusive claim over. Where this is the case, an entity account is created for each affiliate 116 by a representative of the operator of the platform 100 in a manner paralleling the debt settlement company 104 entity account creation process, i.e., including entering their identifying information, banking 118 information (to enable disbursement thereto), and so on. In such a case, the platform 100 initiates disbursements to the affiliates 116 in conjunction with disbursements to the company 104, in accordance with the agreed upon fee-split arrangement between each affiliate 116 and the debt settlement company 104.

Although various actions such as client entity account creation and creditor entity account creation are described herein as occurring in response to a representative of the company 104 entering data into a website 108, these actions may be brought about other ways. For example, the platform 100 may extend API's that permit a debt settlement company 104 to command the platform 100 to take such actions as a consequence of API calls originating from the company's 104 computing platform, wherein such API calls may contain data entered or acquired via software running on the company's 104 computing platform. Moreover, a representative of the company 104 may call the processor's call center 122 and initiate such actions via telephonic conversation with the processor's personnel.

During the period of debt settlement, the client 102 may access a website 124 that is intended for use by clients 102 desiring to interact with the platform 100. Via the website 124, the client 102 may view information related to his client entity account and ledger account (discussed later, below), such as its current balance. The client 102 may also view a list of scheduled and completed transactions, e.g., scheduled and completed drafts, fees and creditor payments, within his client 102 account. The client 102 may also view and initiate alteration of his personal information and banking information via the website 124. The client 102 may perform these same actions via an application 126 running on a smartphone, tablet or personal computer, or via discourse with an agent at the call center 122.

As mentioned previously, a client's 102 funds, when held in the aggregated custodial bank account at the processor's bank 112, typically continue to be owned by the client 102 until such time as an agreed upon payment is made to a creditor 106, or a fee is earned by and posted to a debt settlement company 104 (and its affiliates 116, should it have any) or the payment processor, itself. The funds in the aggregated account are thus typically subject to ownership claims by clients 102, debt settlement companies 104 and potentially affiliates 116. For each client 102, company 104 and affiliate 116, the platform 100 maintains a ledger account to keep track of their respective balances, i.e., to keep track of their respective ownership claim over moneys deposited in the aggregated account. For a given party, its ledger account includes the transactions (drafts, payments, fees, and other various debits and credits, including their dates and amounts) by which its ownership claim of the funds in the aggregated account was adjusted, and includes a balance reflecting the net effect of all such transactions on the party's aforementioned ownership claim. A ledger account is typically not kept for a creditor 106. The platform 100 makes payments to a creditor 106, and upon their receipt, the creditor 106 comes to own the funds that were the subject of the payments, but the platform 100 does not ordinarily assign an ownership interest in the funds to a creditor 106 while the funds remain in the aggregated custodial account at the bank 112. Therefore, the platform 100 does not ordinarily maintain a ledger account on behalf of a creditor 106, because a creditor 106 does not ordinarily have an ownership interest in the funds held at the bank 112.

As mentioned previously, an account that identifies an entity (such as a client 102, debt settlement company 104, creditor 106 or affiliate 116) to the platform 100 may be referred to as an “entity account.” An account that includes the transactions (drafts, payments, fees, and other various debits and credits, including their dates and amounts) by which an entity's ownership claim of the funds in the aggregated account was adjusted may be referred to herein as a “ledger account.” A ledger account is associated with an entity account, and other information, such as a client's 102 future scheduled payments, may be associated with the aforementioned client's 102 entity account, although not yet entered into his or her ledger account.

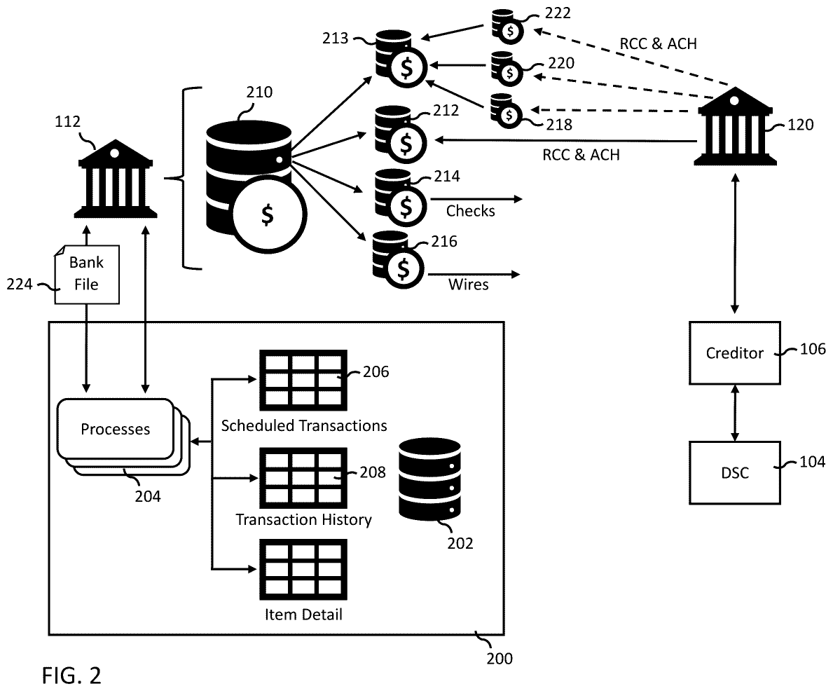

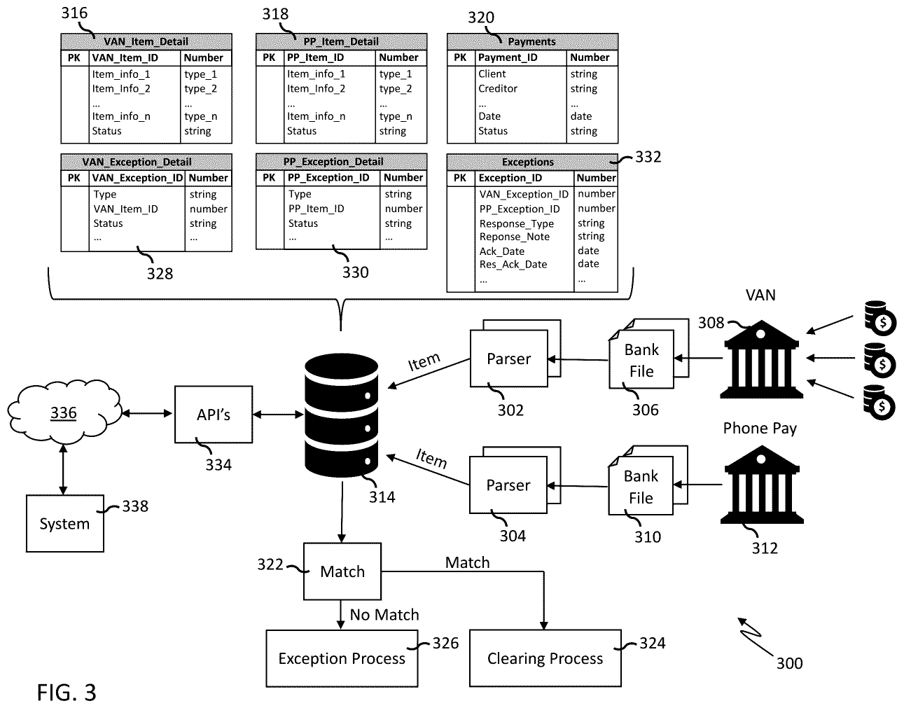

FIG. 2 depicts a more detailed view of a payment processing platform 200, in accordance with some embodiments of the invention. As can be seen from FIG. 2, the payment processing platform 200 includes a data store 202 and processes 204 that interact with the data store 202. According to some embodiments, the data store 202 is a database, such as a relational database. For the sake of simplified discussion only, the data store 202 will ordinarily be referred to herein as a database. The database 202 stores information concerning each payment that is scheduled to be made to any given creditor 106 by any given client 102, and includes the payment type or payment mechanism by which the scheduled payment is to be made. Example: the database 202 stores records that indicate that on a particular date, a particular client 102 is to pay a particular creditor 106 a particular sum of money via a particular payment mechanism as part of a regimen to settle a particular debt identified by a particular account number recognized by the creditor (example: a credit card number). According to some embodiments, this information is stored in a “Payments” table (depicted and discussed with reference to FIG. 3), with each such scheduled payment transaction being identified by a key, which may be referred to as Payments_ID. Additionally, according to some embodiments, this information is stored in a “Scheduled Transactions” table 206.

According to some embodiments, the processes 204 periodically examine the “Payments” table or “Scheduled Transaction” table 206 to determine which scheduled transactions (example: a scheduled payment or fee) have come due. A scheduled transaction has come due if: (1) its effective date (i.e., the date upon which the scheduled payment is to be made) is either equal to the date of execution of the process 204 or precedes it; and (2) it has an active status, i.e., it has not already been processed and remains eligible for processing.

Turning to payment transactions in particular, upon determining that a particular scheduled payment has come due, the scheduled payment is processed. According to some embodiments, when processing a scheduled payment, the processes 204 cooperate to mark the status of the payment transaction as inactive in the “Payments” table or “Scheduled Transactions” table 206, and to enter a record representing the payment transaction into the “Transaction History” table 208 with a “pending” status. Next, the processes 204 cooperate to determine whether the payment should, in fact, be made to the creditor 106 (example: the processes 204 determine whether there is a sufficient balance in the client's 102 ledger account to fund the payment). If it is determined that payment should be made, the aforementioned record in the “Transaction History” table 208 is set to an “internally cleared” status, and the processes 204 cooperate to communicate with the processor's bank 112 to instruct it to transfer funds from the aggregated custodial account 210 into a disbursement account 212, 213, 214 or 216, in an amount equal to the payment amount within the aforementioned record. At this point and according to some embodiments, the combined effects of the actions of the processes 204 is that the “Transaction History” table 208 contains a record with a reference number uniquely identifying the payment and its various informational elements (a payment identifier uniquely assigned to the payment record, a client identifier or payor information, a payment amount, a transaction date, a creditor identifier or payee information, a payment status of “internally cleared”, a payment mechanism identifier, an account identifier of the particular debt under settlement via the payment, and so on), and the processes 204 have commanded the bank 112 to transfer funds in an amount equal to the payment amount from the aggregated custodial account 210 to a disbursement account 212, 213, 214, or 216. With regard to commanding the bank 112 to transfer funds to disbursement accounts 212, 213, 214, and 216, the processes 204 may operate on a payment-by-payment basis, or on an aggregate basis, commanding aggregate sums to be transferred from the custodial account 210 to the disbursement accounts 212, 213, 214, and 216, where the aggregate sums represent the sum of all of the payments to be made via a particular disbursement account during the payment period.

According to some embodiments, separate disbursement accounts 212, 213, 214 and 216 are maintained at the processor's bank 112 to hold funds that are the subjects of particular payment mechanisms to be initiated during the payment period. Thus, for example, funds that are to be paid to a creditor 106 via a wire transfer may be commanded by the processes 204 to be moved to wire disbursement account 216, while funds that are to be paid to a creditor 106 via a physical check may be commanded by the processes 204 to be moved to check disbursement account 214, and so on. As can be seen from FIG. 2, according to some embodiments, funds that are to be “pulled” by the creditor 106 either via a remotely created check (RCC) or via an automated clearing house (ACH) transaction are transferred to disbursement accounts 212 and 213.

Disbursement account 212 may represent a plurality of accounts—one disbursement account 212 designated for each particular debt settlement company (such as debt settlement company 104) serviced by the payment processor. A disbursement account such as the one depicted by account 212, i.e., one that is uniquely associated with a debt settlement company 104, may be referred to herein as a “phone pay disbursement account.” Therefore, on a scheduled basis, such as a daily basis, a given debt settlement company (such as debt settlement company 104) may inform each creditor (such as creditor 106) with which it has negotiated a settlement on behalf of a client 102, that it is to “pull” a set of client payments from its aforementioned particular designated phone pay disbursement account 212. A given creditor (such as creditor 106), in turn, instructs its bank (such as bank 120) to initiate a “pull” of funds from the aforementioned phone pay disbursement account 212, on a one-pull-for-each-payment basis. Each such “pull” mechanism may be conducted as an RCC or ACH instrument. A different debt settlement company would direct each of the creditors with which it has negotiated a settlement on behalf of a client 102 that it is to “pull” payments from a different particular phone pay disbursement account 212, i.e., one that the processor has designated for the aforementioned different debt settlement company. Again, each such “pull” mechanism may be conducted as an RCC or ACH instrument.

On a schedule, such as each day, the payment processor's bank 112 prepares bank files 224 (example: an X9 file or an ACH file, or derivatives thereof) for the payment processor to retrieve, such as via a file transfer protocol (FTP) exchange. The bank 112 produces two files for each disbursement account 212 or 213 from which funds are to be pulled: (1) one file contains a set of descriptive data for each RCC transaction that “pulled” funds from a given account; and (2) the other file contains a set of descriptive data for each ACH transaction that “pulled” funds from the aforementioned given account. Each set of data within a bank file 224 describing either an ACH or RCC that “pulled” data from a disbursement account is referred to as an “item” or a “bank item.” Thus, for a given account 212 or 213, if an aggregate quantity of n RCC and ACH transactions “pulled” funds from the given account since the last production of such files 224, then the two bank files 224 produced by the bank 112 for the aforementioned given account 212 or 213 will contain an aggregate quantity of n items. A bank item associated with a phone pay disbursement account 212 may be referred to herein as a “phone pay bank item” or “phone pay item.”

A phone pay bank item can be associated with the particular debt settlement company 104 for which that the disbursement account is designated. This is because each such item is associated with the particular bank file 224 in which it was communicated to the payment processor's platform 200, and each bank file 224 is associated with a particular phone pay disbursement account 212, and each particular phone pay disbursement account 212 is associated with a particular debt settlement company 104, meaning that it is the case that each item is associated with a particular debt settlement company 104 by virtue of the just-stated chain of associations.

Items originating from bank files 224 associated with disbursement accounts of the sort depicted by account 213 also can be associated with the particular debt settlement company 104 for which that the disbursement account is designated, although the chain of associations permitting such bank-item-to-debt-settlement-company association is different than just described above. Disbursement account 213 is associated with virtual accounts 218, 220 and 222. Such association or “mapping” between the virtual accounts 218, 220 and 222 and the actual disbursement account 213 is typically maintained by the payment processor's bank 112. Each virtual account 218, 220 and 222, is, in turn, uniquely associated with a specific client 102. (This association between a virtual account 218, 220 and 222 and a client 102 is stored in the data store 202 of the payment processing platform 200.) An RCC or ACH instrument directed toward a virtual account 218, 220 or 222 in fact “pulls” money from the actual disbursement account 213. Thus, when a given creditor 106 intends to “pull” funds from a disbursement account 213 in order to complete a payment from a particular client 102, the creditor 106 directs its ACH or RCC instrument toward the virtual account 218, 220 or 222 corresponding to the particular client 102 making the payment that is to be completed by the ACH or RCC instrument. A disbursement account that is associated with virtual accounts 218, 220 and 222, each of which are uniquely associated with a client 102, may be referred to herein as a “VAN” disbursement account. (VAN stands for “virtual account number.”). According to some embodiments a VAN disbursement account 213 is not uniquely associated with any particular debt settlement company 104, and may “map” to virtual accounts 218, 220 and 222 that correspond to clients 102 of more than one debt settlement company 104. Thus, a bank (such as bank 112) maintaining a VAN disbursement account 213 may maintain as few as one such account 213. According to other embodiments, a VAN disbursement account uniquely 213 corresponds to a debt settlement company 104 or a set of debt settlement companies 104. A bank file 224 associated with a VAN disbursement account 213 contains items pertaining to each of its associated virtual accounts 218, 220 and 222. Thus, because each item in such a bank file 224 is associated with a virtual account 218, 220 or 222, and because each virtual account 218, 220 and 222 is uniquely associated with a client 102, and because each client 102 is associated with a debt settlement company 104, each item in bank file 224 associated with VAN disbursement account 213 may be associated with both debt settlement company 104 and a client 102, by virtue of the just-stated chain of associations. A bank item associated with a VAN disbursement account 213 may be referred to herein as a “VAN bank item” or “VAN item.”

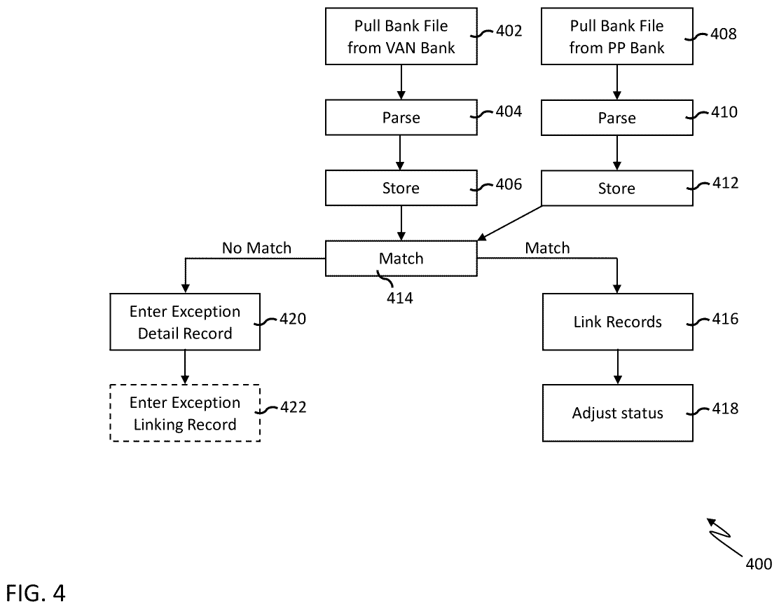

FIG. 3 depicts a software system 300 implemented by the payment processor's computing platform 200 of FIG. 2. The software system 300 performs the acts comprising the method 400 depicted in FIG. 4. As can be seen from FIG. 3, the system 300 includes parsers 302 and 304. Parser 302 is structured to retrieve (such as via the FTP technology or a similar such protocol) bank files 306 from a computational platform operated by or on behalf of a bank 308 that maintains a VAN disbursement account, and to read the information therein. Thus, parser 302 may read each item in a given bank file 306, and may read each informational element within each such item. Parser 302 may represent more than one such parser 302. For example, parser 302 may represent a first parser 302 for bank files 306 containing items describing ACH instruments drawing upon the VAN distribution account at the bank 308, and may also represent a second parser 302 for bank files 306 containing items describing RCC instruments drawing upon the aforementioned VAN distribution account. Parser 304, on the other hand, is structured to retrieve (such as via the FTP protocol or a similar such protocol) bank files 310 from a computational platform operated by or on behalf of a bank 308 that maintains one or more phone pay disbursement accounts, and to read the information therein. Thus, parser 304 may read each item in a given bank file 310, and may read each informational element in each such item. As with parser 302, parser 304 may represent more than one such parser 304. For example, parser 304 may represent a first parser 304 for bank files 310 containing items describing ACH instruments drawing upon the phone pay distribution account at the bank 312, and may also represent a second parser 304 for bank files 310 containing items describing RCC instruments drawing upon the aforementioned phone pay distribution account.

In operation, from time to time (example: once per business day, or periodically throughout a business day, etc.), parser(s) 302 retrieve bank files 306 from the computational platform of bank 308 (operation 402), which maintains a VAN disbursement account. In the event that the retrieved bank file 306 contains items describing ACH instruments drawing upon the aforementioned VAN disbursement account, then each such item in the file may contain informational elements about each ACH instrument it describes, such as: (1) the name of the payor, e.g., the client's 102 name; (2) the name of the payee, e.g., the creditor's 106 name; (3) the amount of the payment; (4) the date of its settlement; (5) its ACH trace number; (6) an ID number used to identify the payor (client 102) by the payee (creditor 106); (7) a standard entry class (SEC) code describing the means by which the ACH payment was authorized; and (8) memoranda data, containing free-form textual description associated with the ACH instrument. On the other hand, in the event that the retrieved bank file 306 contains items describing RCC instruments, then each such item in the file main includes informational elements about the RCC instrument it describes, such as: (1) the payment amount, i.e., the payment amount reflected on the RCC; (2) the check number reflected on the RCC; (3) a sequence number identifying the RCC; (4) the date of its settlement; and (5) the particular virtual account number the item was applied against—from this information the client's 102 name can be deduced, as described previously. For each item, image data of the corresponding RCC is also contained in the bank file 306.

In operation 404, the parser(s) 302 read each informational element from each item, and, in operation 406, store each such element in a data store 314. According to some embodiments, each such item within the bank files 306 is stored in a VAN_Item_Detail table 316, in association with a unique identifier such as a key, although this need not be the case, as discussed below. Each record within the VAN_Item_Detail table 316 contains a VAN_Item_ID field (which is the aforementioned key), and also may include fields storing each of the aforementioned informational elements resulting from having parsed either an ACH or RCC item. Finally, each such record contains a status field that indicates the processing status of the item along its way to being matched to a scheduled payment transaction record (or being returned). Thus, conceptually, each such record may appear as: {VAN_Item_ID, payor_name, payee_name, paid_amount, . . . , status}.

Although each record in the VAN_Item_Detail table 316 is described as containing fields to store each of the aforementioned informational elements, it will be understood that the VAN_Item_Detail table 316 may include fields directly storing only some of those elements, and that some of the other elements may be stored in records within other tables. Thus, the records of the VAN_Item_Detail table 316 may contain references (example: foreign keys, etc.), and such references may be used to link a given record (i.e., an item record) within the VAN_Item_Detail table 316 to informational elements from the item that may be stored in other tables. In situations in which the information from records of a given table is sufficient to properly associate any given record with other additional information stored in other records within other table(s), those records within the aforementioned given table may be described herein as containing such other additional information, although such additional information is in fact stored in other tables. The embodiments disclosed herein are not confined to any particular data schema, and should be understood in view of their general principles.

It is of note that, according to some embodiments, in the event that bank file 306 being processed by the parser 302 contains items describing RCC instruments, then the item records created in operation 406 will not contain data in certain fields: the payee field and the memo field. The reason for this is that the bank file 306 contains information pertaining to the payees and/or any memorandum data only in the image data of the various RCC's described therein. These fields are supplied with data at a later stage of operation when the image data is accessed, as discussed below.

Turning to operations 408, 410 and 412, these operations are similar to operations 402, 404 and 406, respectively, except that their activities are directed to bank files 310 associated with a phone pay disbursement accounts (depicted as being maintained by bank 312). Operations 408, 410 and 412 cooperate to retrieve bank files 310 from time to time, and to read such files 310, storing their informational elements (the same informational elements as were described above in the discussion pertaining to the VAN disbursement account) in the data store 314 as item records. For the sake of brevity, their operations are not re-described herein, except to state: (1) that, according to some embodiments, such item records may be stored in a PP_Item_Detail table 318, identified by a unique identifier or key (PP_Item_ID); and (2) that, according to some embodiments, in the immediate wake of operations 408-412, the item records created in operation 412 will not have data stored in the fields corresponding to payee information, memorandum information or payor information—such information is contained in RCC image data, and these fields are supplied with information when such image data is accessed.

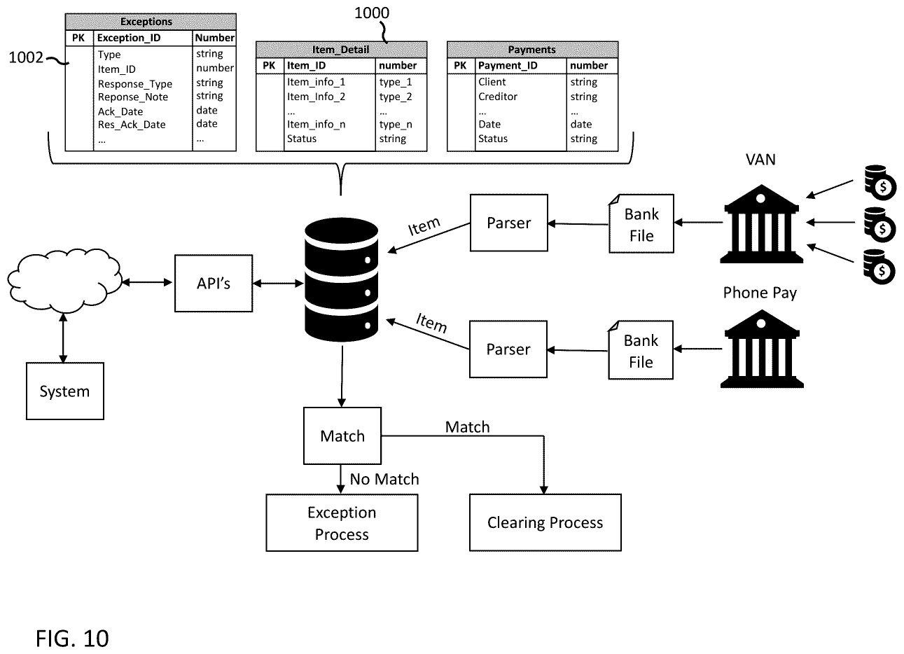

The net result of operations 402-412 is that tables 316 and 318 contain records that, in total, describe each of the items in the various bank files 306 and 310 retrieved by the parsers 302 and 304 during operations 402 and 408. Each record in tables 316 and 318 represents a bank item, which, in turn, describes either an ACH instrument or an RCC instrument. Although tables 316 and 318 are depicted in FIG. 3 as being separate—one table 316 to contain items pertaining to VAN disbursement accounts, and one table 318 to contain items from phone pay disbursement accounts—this need not be the case, as is discussed in greater detail with reference to FIG. 10, below.

In operation 414, a matching process or module 322 selects a bank item from the data store 314 (for example, from table 316 or 318), and attempts to match it to a payment transaction record. According to some embodiments, payment transaction records are embodied as records within a Payments table 320 within the data store 314. Such a record is identified uniquely by an identifier or key, Payment_ID. Conceptually, a payment transaction record is structured as follows:

{Payment_ID, client, creditor, amount, effective date, . . . status}.
Such a record would mean that the particular record identified by the data stored in the Payment_ID field refers to a client payment scheduled to have been made by a client 102 identified by the data in the “client” field to a creditor 106 identified by the data in the “creditor” field, in an amount determined by the data in the “amount” field, on a date determined by the data in the “effective date” field, (and so on), and, finally, that the client payment has a status described by the data in the “status” field. A match may be declared, for example, if a bank item and a payment transaction record share a common client, creditor, amount, debt account number, and the effective date of the payment transaction record is within a tolerance of the date of the item (example: +/−30 days or 90 days), if the status of the payment transaction record reveals that it has not already been cleared (which is the result of having already been matched with another item) and that it has not otherwise been voided, reversed or held. Under such circumstances, there is a near certainty that the bank item describes a payment instrument that was created in order to effectuate the particular client payment described by the “matched” payment transaction record. If a match is declared between a bank item and a payment transaction record, then the match is indicated in the records within the data store 314, as described below.

Other conditions exist under which a match may be declared, although a complete discussion of such matching requirements and strategies is beyond the scope of the present document. For present purposes, the following discussion suffices. Matching generally proceeds in stages. The stages are arranged so that, if proceeded through in order, the matching process will identify the particular payment transaction record having the highest probability of being correctly matched with the particular bank item being subjected to the matching process. For example, the matching requirements employed at stage1 of a matching process may be designed so that if a particular payment transaction record satisfies such requirements, then it is a near certainty that the aforementioned payment transaction record does, in fact, identify the particular client payment that the payment instrument described by the bank item was intended to effectuate, i.e., it is a proper match. If no transaction record satisfies the matching requirements of stage1, the process proceeds on to stage2, wherein the matching requirements are relaxed. If a given payment transaction record satisfies the matching requirements of stage2, then it is the case that the aforementioned given payment transaction record is the best match to the particular bank item being subjected to the matching process. If no payment transaction record satisfies the matching requirements of stage2, then the process proceeds on to stage3 which employs matching requirements that are relaxed still further, and so on, until no further matching stages exist. If no payment transaction record satisfies any of the requirements of any of the stages, then an exception is declared.

At some point during the progression through the matching process, the requirements for introduction of payment transaction records into the pool of candidates to be tested to determine if they exhibit a match may be relaxed in order to result in an expanded pool (example: such relaxation may occur in the wake of stage1 or stage2). The pool may be expanded to include payment transaction records that are not eligible to be actually declared a match because, for example, they were scheduled for a client that has since closed his or her account, or because the client payment described by the payment transaction record has previously been voided, reversed or held (a payment instrument should not have been created to effectuate a client payment that was voided, previously reversed or held). In other words, the pool may be expanded to include payment transaction records that describe scheduled payments, that could conceivably have been consummated by a payment instrument, but, if that were the case, such consummation would have been in error.

According to some embodiments, it is the case that, in the event that an exception is declared by the matching process, that an exception type code or string is associated with the exception. The exception type may result from a circumstance in which: (1) one of the additional candidate payment transaction records resulting from pool expansion satisfies the matching requirements of a matching stage, while (2) no payment transaction record eligible to be declared a match, in fact, satisfies the matching requirements of any of the stages. An additional candidate payment transaction record that satisfies the matching requirements of a matching stage when no eligible payment transaction record does is referred to as a “strong match.” When a payment transaction record is designated as a “strong match” to a bank item, this may be interpreted to mean: “this particular payment transaction record would actually match this particular bank item but for the fact that the payment transaction record is ineligible to be matched for this particular reason.” (Examples: (1) “this particular payment transaction record would be declared a match to this particular bank item, but it refers to a client payment scheduled for a client who has closed his or her account after the payment was scheduled. Therefore, a creditor should not be “pulling” money from a disbursement account to effectuate this payment, because the client is no longer part of a debt settlement program.” (2) “This particular payment transaction record would be declared a match to this particular bank item, but it refers to a client payment that had been previously voided. Therefore, a creditor should not be “pulling” money from a disbursement account to effectuate this payment, because the client payment is void.”).

It should be noted that, in the course of operating upon a bank item describing an RCC instrument, the matching process 322 accesses the image data (mentioned above) of the underlying RCC in order to obtain certain informational elements of the item: payee, memorandum data, and payor. According to some embodiments, this information is introduced directly into the record constituting the bank item being operated upon by the matching process (either in the VAN_Item_Detal table 316 or PP_Item_Detail table 318), or, according to other embodiments, this information is introduced into the data store 314, for example, as a record in another table and is associated with the aforementioned item record, such as with a foreign key.

If the clearing process or module 322 declares a match between a particular bank item it is operating upon and an eligible payment transaction record from the aforementioned candidate pool, then a clearing process or module 324 performs the tasks of linking the matched bank item and payment transaction record in the data store 314 (operation 416). For example, the identifier of the matched payment transaction record (Payment_ID) may be introduced into a field in the bank item detail record, so as to associate the two records. Thereafter, in operation 418, the status field of the transaction payment record is set to indicate that it has been cleared (i.e., that not only were its funds allocated to a disbursement account, but that a payment instrument initiated by the appropriate party actually pulled the funds from the disbursement account in order to complete or effectuate the client payment). The combined effect of operations 416 and 418 is that the record of a successfully matched bank item contains a reference to a payment transaction record with a “cleared” status, as opposed to some other status. If a particular bank item record contains a reference to a payment transaction record that does not have a “cleared” status, this is an indication that the payment transaction record is a not an actual match—it is only a “strong match.”

If the matching process or module 322 declares an exception, then an exception process or module 326 is invoked. The exception process or module 326 creates an entry in an exception detail table, such as VAN_Exception_Detail table 328 or PP_Exception_Detail table 330. A record in the VAN_Exception_Detail table 328 contains information about an exception event related to a bank item detail record in the VAN_Item_Detail table 316 that could not be matched by the matching module or process 322. Its main informational elements are: (1) a unique identifier or key (such as a unique number contained in a “VAN_Exception_ID” field) used to identify the exception; (2) a reference to the bank item detail record in the VAN_Item_ID table 316 to which the exception detail record is referring (contained in a “VAN_Item_ID” field); (3) an indication of the exception type (indicated by a string contained in the “type” field); and (4) an indication of the status of the exception detail record, discussed below. Such an exception detail record may contain additional informational elements, as well. In a parallel fashion, a record in the PP_Exception_Detail table 330 contains information about an exception event related to a bank item detail record in the PP_Item_Detail table 318 that could not be matched by the matching module or process 322. Its main informational elements are: (1) a unique identifier or key (such as a unique number contained in a “PP_Exception_ID” field) used to identify the exception; (2) a reference to the bank item detail record in the PP_Item_ID table 318 to which the exception detail record is referring (contained in a “PP_Item_ID” field); (3) an indication of the exception type (indicated by a string contained in the “type” field); and (4) an indication of the status of the exception detail record, discussed below. Again, such an exception detail record may contain additional informational elements, as well. Although exceptions related to VAN and phone pay items are depicted and discussed with reference to FIG. 3 as being stored in separate tables 328 and 330, this need not be the case. This is discussed further, below.

Finally, in operation 422, the exception process 326 enters a record into an Exceptions table 332. The purpose of the Exceptions table is to contain records that unify exceptions contained in tables 328 and 330. The records in the Exceptions table 332 include informational elements such as: (1) a unique identifier or key (such as a unique number contained in an “Exception_ID” field); (2) a reference to the underlying exception detail record to which the “unifying” record refers (either a VAN_Exception_ID or a PP_Exception_ID); and (3) other fields that will be discussed below.

As can be seen in FIG. 3, a system 338 may access and present to its users information related to exceptions via application interfaces (API's) 334 that are accessible via a network 336, such as open network like the Internet. For example, the API's 334 may be structured as server-side web API's, and the information may be presented via the user interface of a website (such as website 108) or some other application, such as an application executing on a computing platform operated by a debt settlement company 104. In either case, the purpose of the API's 334 and system 338 is to permit personnel of a debt settlement company 104 to review exceptions and evaluate them. The outcome of such an evaluation typically falls into certain categories: (1) the bank item is unmatched because the underlying RCC or ACH instrument never should have been created in the first place, meaning the funds that were pulled from a disbursement account because of such instrument should be returned; (2) the bank item is unmatched, but the personnel of the debt settlement company 104 (having superior information about either their client or the creditor) are able to properly match the bank item to a payment transaction record; or (3) the bank item is unmatched, but the personnel of the debt settlement company 104 conclude that the payment transaction record to which the bank item should have been matched was simply inadvertently not created. After having formed a conclusion about a particular exception, the personnel of the debt settlement company 104 can provide instructions relating to how to resolve the exception, in view of his or her conclusion.

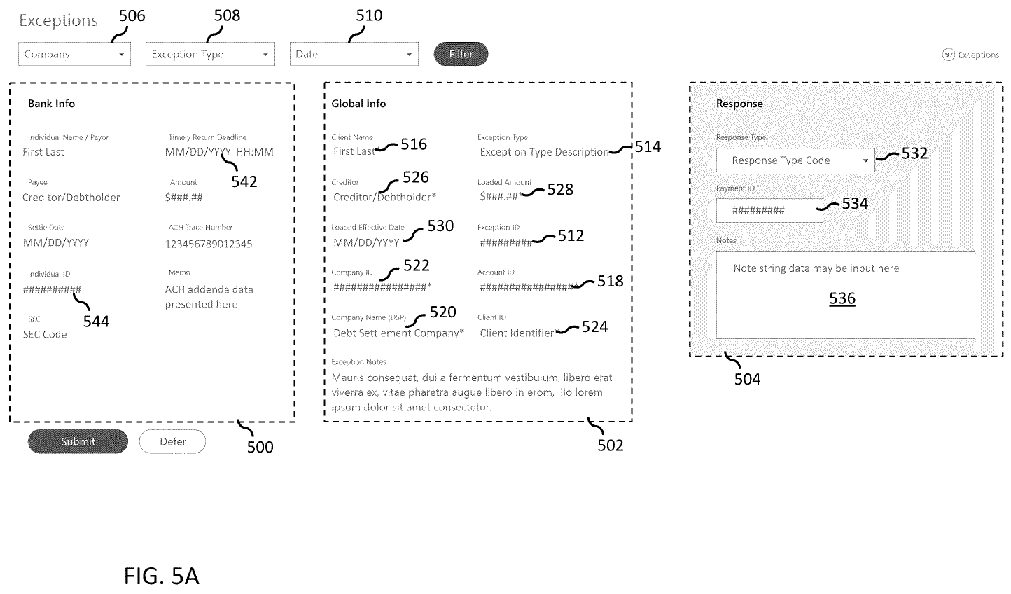

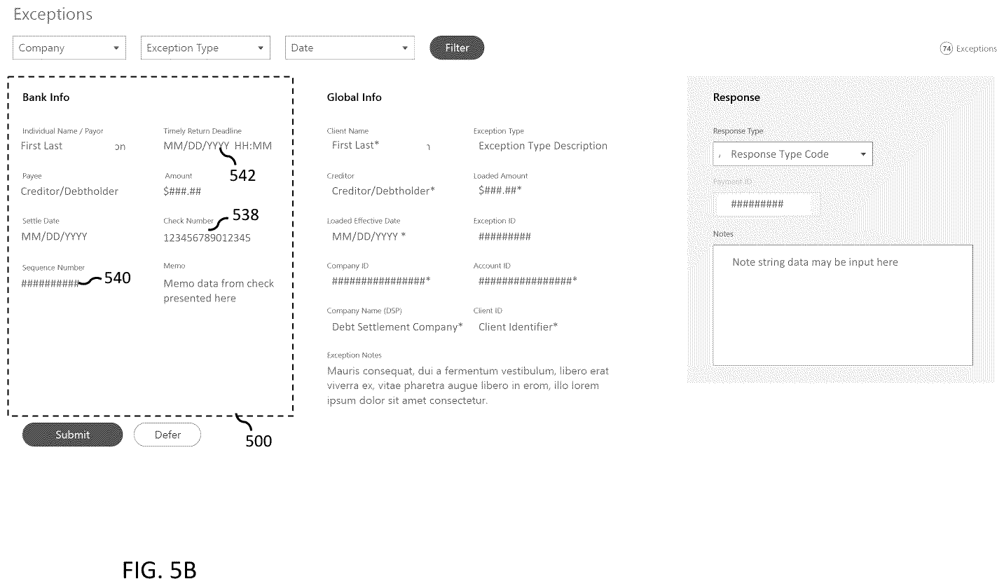

FIGS. 5A and 5B depict examples of user interfaces by which a representative of a debt settlement company 104 could review a given exception and provide feedback based upon his or her evaluation. The user interface of FIG. 5A presents information pertaining to an exception event declared with respect a bank item describing an ACH instrument, whether directed at a VAN or phone pay disbursement account. As can be seen from FIG. 5A, the user interface includes three regions 500, 502 and 504. In region 500, the unmatched bank item information that was obtained directly from its item entry or image data (in the case of an RCC) in its respective bank file 306 or 310 is presented (with one exception, which is discussed below). The information presented in region 500, with one exception, is the same as that described above (with reference to operation 402 of FIG. 4) as being contained in an item of a bank file 306 describing ACH instruments, and for the sake of brevity, these informational elements are not re-described here.

Turning to region 502, it contains information that is either: (1) created during the declaration of an exception (operation 414) and the subsequent creation of its exception record (operations 420 and 422); (2) derivable from the chain of associations between the particular virtual account to which a VAN item was directed and a client entity account; and/or (3) derivable from a strong match with a payment transaction record. Specifically, the region includes an exception identifier 512, which is the VAN_Exception_ID or PP_Exception_Id from the particular exception detail table 328 or 330 storing the exception being displayed, and an exception type 514, which is the data from the “type” field from the aforementioned exception detail table 328 or 330. These two informational elements 512 and 514 are always present, because they are created as part of the process of having declared an exception and created its corresponding exception record. In the event that the exception being viewed pertains to an item that pulled funds from a VAN disbursement account, then the particular client 102 associated with the virtual account number is determinable by virtue of the associations described previously. Consequently, information that is, itself, associated with the client 102, is presented in such a scenario: (1) the client's 102 first and last name 516; (2) the client's entity account identifier 518 uniquely identifying the client entity account in the processor's data store 314; (3) the name of the debt settlement company 520 that created the client entity account for the client 102 during the above-mentioned entity-account-creation process; (4) a unique identifier 522 identifying the aforementioned debt settlement company 104, which was created at the time of creation of the debt settlement company's 104 company entity account; and (5) a client identifier 524 used by the debt settlement company 104 to identify the client 102 in its system, entered by a representative of the debt settlement company 104, during the above-described client entity account creation process. Finally, in the event that the exception being viewed relates to a bank item that, when subjected to the aforementioned matching process 414, had a payment transaction record that was a strong match, then all of the informational elements 516-524 that are presented by virtue of their association with a specific client 102, are also presented in this scenario. This is because a payment transaction record includes a client entity account identifier (informational element 518) to identify the client's entity account, and based on such account identifier, the other such elements can be determined. A payment transaction record also includes an indication of the creditor to which the payment is to be made, the amount of the payment, and the effective date of the payment, and these informational elements 526, 528 and 530 are also presented in region 502 under such circumstances.

Region 504 of the user interface may be accessed by the user to enter information used by the processor to resolve the exception. The region 504 includes a drop-down menu 532 from which the user may select a response code, which is an instruction to the payment processor conveying steps the processor should take in order respond to the exception in order to rectify it so that the bank item that is the subject of the exception being viewed either: (1) will be matched with a payment transaction record in the wake of having performed the aforementioned steps; or (2) will be returned so that the payment processor no longer has an unmatched bank item in its data store 314 (and so that the funds associated with such unmatched items are returned to the disbursement account by the bank 120 that pulled the funds therefrom on behalf of the creditor 106). The region 504 also includes a user-input field 534 in which the user can enter the unique identifier (“Payment_ID”) of the payment transaction record to which the steps identified in drop-down menu 532 are to be applied, if they are to be applied to a payment transaction record at all. Finally, the region includes a user-input field 536 into which the user may enter free-form instructions or other information in the form of a string.

The user interface of FIG. 5B presents information pertaining to an exception event declared with respect a bank item describing an RCC instrument, whether directed at a VAN or phone pay disbursement account. The user interface of FIG. 5B is identical to that of FIG. 5A, except for minor changes to the informational elements of region 500 to accommodate the fact that the unmatched bank item record describes an RCC instrument, as opposed to an ACH instrument. Specifically, region 500 is modified in FIG. 5B to include check number data 538 and sequence number data 540 (a sequence number is a number assigned to a check to more uniquely identify it than would a check number, which may be chosen by a checking account holder). Moreover, the “Individual ID” data from the user interface of FIG. 5A is eliminated. That particular data field generally contains an account number identifying the particular debt being repaid by the payment (example: it may contain a credit card number in the event that the particular dent being repaid by the client 102 was a credit card debt). This information, if it is contained at all on an RCC, would appear in the memorandum field, which remains present in region 500 of the user interface of FIG. 5B.

The premise of the user interfaces of FIGS. 5A and 5B is that the data presented therein is to be fetched from a local data store that is a component of the system 338 accessed by the user in connection with reviewing the exception information. The data store 338 is, in turn, supplied with the data describing each such exception by virtue of accessing the API layer 334 of the payment processor's computing platform 300.

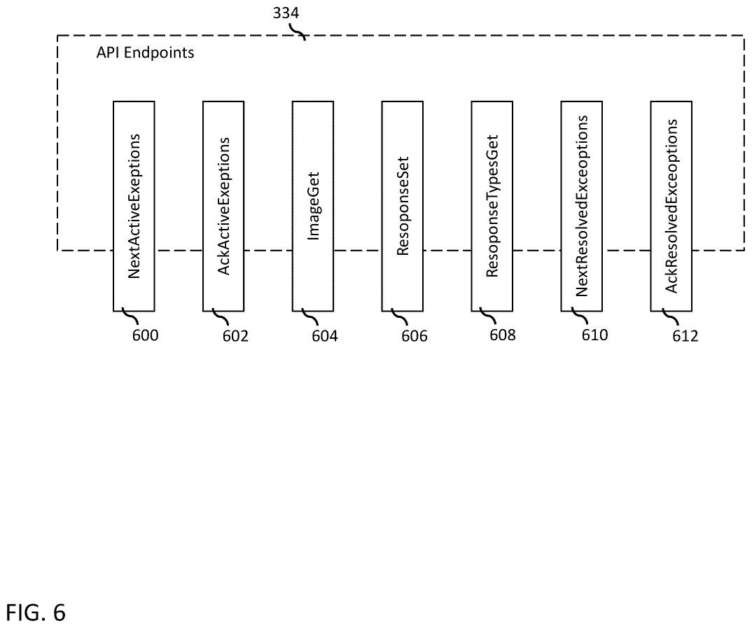

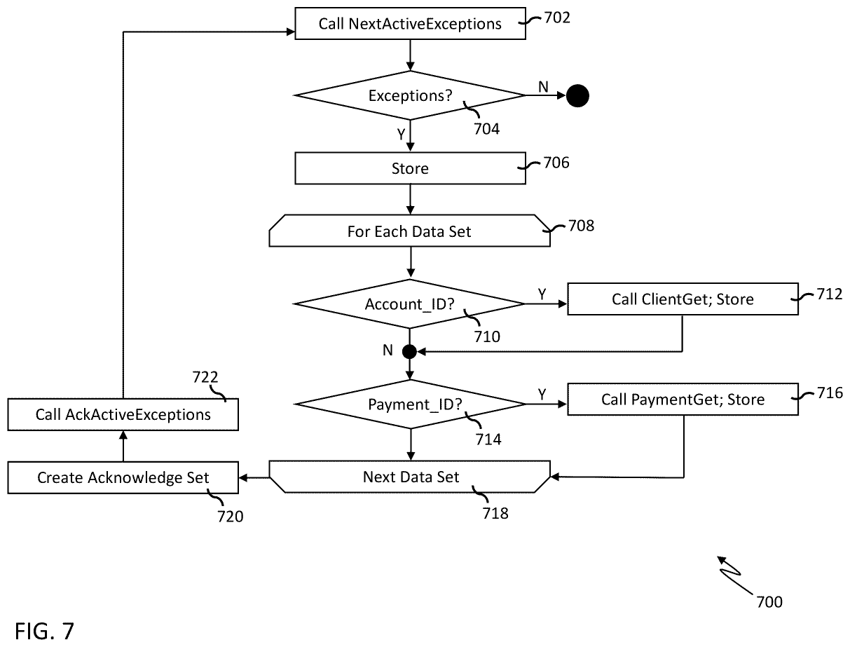

According to some embodiments, the API layer 334 includes the endpoints 600-612 depicted in FIG. 6, and according to some embodiments, the system 338 may populate its data store by execution of the method 700 of FIG. 7. The method 700 of FIG. 7 begins, in operation 702, by the system 338 calling a NextActiveExceptions endpoint 600, such as may be done using a Hypertext Transfer Protocol (HTTP) command—example: an HTTP POST command directed to the NextActiveExceptions endpoint 600. The NextActiveExceptions endpoint extends an API, invokable by the system 338 via the network 336, that may be accessed in order to call a method or function hosted by the platform 300 of the payment processor. The aforementioned method or function responds to invocation by returning an array or list of data sets, wherein each data set contains data elements describing a bank item that was declared an exception. Thus, if it is the case that NextActiveExceptions 600 were to return an array or list with a quantity of n data sets therein, then the response includes information pertaining to a quantity of n bank items, each of which was declared as an exception.

According to some embodiments, the NextActiveExceptions method or function 600 operates so as to: (1) determine which particular exception records have not previously been included in a response to the system 338 and properly read thereby; (2) arrange such as-yet uncommunicated exception records into a priority order; and (3) return a quantity of data sets including information about such exception records and their related bank items, wherein such quantity may be limited by either a default maximum quantity (example: a maximum of 100 such data sets) or by a limit specified by an argument in the API call, itself (example: the POST command directed to the NextActiveExceptions endpoint 600 may include a numerical argument, such as 50, meaning that the response should contain no more than 50 data sets).

According to some embodiments, each data set returned by the NextActiveExceptions endpoint 600 contains all of the data that, for a given exception, would be presented in regions 500 and 502 of the user interfaces of FIGS. 5A and 5B. Thus, assuming that NextActiveExceptions 600 responded to its invocation with a quantity of n data sets, conceptually, its response would be structured as:

```
{ (payor_name₁, timely_return_deadline₁, payee_name₁,
amount₁, ...exception_notes₁),
(payor_name₂, timely_return_deadline₂, payee_name₂,
amount₂, ...exception_notes₂),
  ...
  (payor_nameₙ, timely_return_deadlineₙ, payee_nameₙ,
  amountₙ, ...exception_notesₙ) }.
```

Conceptually, then, each data set could be stored as a record in a data store of the system 338, and when a particular exception was to be presented via a user interface (such as the ones depicted in FIG. 5A or 5B), the record corresponding to the aforementioned exception could be retrieved, and the information from the record could be used to populate the regions 500 and 502 of the user interface.

According to other embodiments, the returned data sets contain only a portion of the information required to populate regions 500 and 502 of the user interface. For example, each data set may include the data contained in bank item that is the basis of the exception, i.e., the data presented in region 500, and may further include: (1) the exception identifier 512 used to uniquely identify the exception at the time of creation of its exception record, and (2) the exception type 512 determined during the attempted matching process 414. Certain other data may be included in a data set, based upon circumstances surrounding the bank item that is the basis of the exception being described by the data of the data set. For example, if the bank item is a VAN bank item or was strongly matched to a payment transaction record during the match process, then the client entity account identifier 518 used by the payment processing platform 300 to uniquely identify the client entity account that is presumed to be associated with the payment transaction record that should be properly matched to the unmatched bank item is included. Additionally, if the bank item was strongly matched to a payment transaction record during the match process 414, then the payment identifier (example: Payment_ID) used to identify the payment transaction record that was strongly matched to the bank item is included. To the extent they are included in the data set, the client entity account identifier and payment identifier may, in turn, be used to access other API's to obtain data used to populate data elements of region 502 other than the exception identifier 512 and exception type 514.

Continuing on with a discussion of the embodiments wherein the returned data sets contain only a portion of the data required to populate regions 500 and 502, after calling the NextActiveExceptions method of function 600 and receiving the response (operation 702), operational flow is passed to operation 704. In operation 704, the response from the endpoint 600 is examined to determine whether it contains any data sets at all. As will be discussed below, the NextActiveExceptions method or function 600 may be structured so as to return data sets describing only those exceptions that have not been previously communicated to the calling system 338 and properly read thereby. Therefore, if the system 338 has been routinely calling the NextActiveExceptions method or function 600 to retrieve exception data (i.e., data sets), it may be the case that there are no exceptions that have not been communicated previously—thus, there may be no data sets in the response. If there are no data sets in the response, then the method 700 is terminated. On the other hand, if the response does, in fact, contain data sets, then each such data set is stored (operation 706) in a data store of the system 338, such as by storing each such data set as a record in a table. After having stored the data sets, each such data set is examined and perhaps expanded with additional data by the operational loop defined by loop limit operators 708 and 718. In operation 710, the particular data set indicated by loop limit indicator 708 is examined to determine whether it includes client entity account identifier data 518, which, as was described above, may be possible under certain circumstances. If the data set includes a client entity account identifier 518, then the account identifier 518 is used to call another endpoint of the API Layer 334, Client_Get (not depicted) (operation 712), to obtain data associated with the client entity account, such as the following data: the client name 516, the name 520 of the debt settlement company associated with the client and its identifier 522 (according to some embodiments), and the client identifier 524 used by the debt settlement company to identify the client 102. This data is then stored in the aforementioned data store of the system 338 in association with the data set currently being operated upon by the loop defined by limit indicators 708 and 718. Thereafter, control is passed to operation 714, which is also passed control in the event it was determined in operation 710 that the data set currently being operated upon did not contain account identifier data 518.

In operation 714, the particular data set indicated by loop limit indicator 708 is examined to determine whether it includes payment identifier data (example: Payment_ID) (the scenario under which this is possible is described above). If the data set includes a payment identifier, then the payment identifier is used to call another endpoint of the API Layer 334, Payment_Get (not depicted) (operation 716), to obtain data associated with the payment transaction record referenced by the payment identifier, such as the following data: the creditor name 526, the loaded amount 528, and the loaded effective date 530. This data is then stored in the aforementioned data store of the system 338 in association with the data set currently being operated upon by the loop defined by limit indicators 708 and 718. Thereafter, control is passed to loop limit indicator 718, whereupon operations 710, 712, 714 and 716 are performed once more, this time operating upon the next data set of the returned information. On the other hand, if all of the returned data sets have been operated upon by operations 710, 712, 714 and 716, then control is passed to operation 720.

Prior to discussion of operation 720 some backdrop is required. Previously, it was stated that the NextActiveExceptions method or function 600 may determine which particular exception records have not previously been included in a response to the system 338 and properly read thereby. To do this, the function or method 600 requires a source of exceptions to inspect. In the context of embodiments where VAN exceptions and phone pay exceptions are stored in separate tables 328 and 330, but the existence of such exceptions has been memorialized by exception records in a single unifying Exceptions table 332, the Exceptions table 332 may be queried. Specifically, each particular record in the Exceptions table 332 may contain a field indicating whether or not the particular exception record has been communicated to the system 338 and properly read thereby. For example, the system 338 may verify that it has, in fact, properly read certain data sets returned by NextActiveExceptions 600, and such verification may be represented by the date of such verification being stored as a data element in an acknowledgement field within each exception record in the Exceptions table 332. Thus, NextActiveExceptions 600 may formulate a query to return the set of exception records withing the Exceptions table 332 having no date contained in the acknowledgement field, in order to identify those exception records that have not previously been included in a response to the system 338. To verify that certain data sets were properly read, the system 338 may call the AckActiveExceptions endpoint 602 of the API layer 334 with a list of exception identifiers of those particular exception records it has properly read. AckActiveExceptions 602 is structured to respond by storing the date of its invocation in the acknowledgement field of each exception record, the identifier of which is included in the aforementioned list. With this backdrop, then, in operation 720, a list or set of exception identifiers to be verified as having been properly read is created, and in operation 722, the list is supplied as an argument to a call from the system 338 to the AckActiveExceptions endpoint 602, thereby causing it to respond by entering the present date in the acknowledgement field of each exception record identified in the list or set, meaning that each such exception record is acknowledge by the system 338 as having been properly read.

After execution of operation 722, the system 338 may return to operation 702, in order to obtain a new set of data sets describing exceptions that have not yet been communicated to the system 338. For example, the method 700 may be executed on a periodic basis, such as once every fifteen minutes, thirty minutes or sixty minutes. Thus, the method 700 may be embodied as a process that is invoked by a timer.

Before advancing, discussion must return to the exception detail record creation operation 420. According to some embodiments, during such operation, the status field of the newly created exception detail record is set to a value to indicate that its resolution is waiting upon input from the debt settlement company 104. By setting the status thusly, the NextActiveExceptions API 600 is signaled that the exception detail record should be returned to the debt settlement company via the endpoint 600, as opposed to being suppressed from presentation through the endpoint 600. If the status of a given exception detail record contained a different value, the NextActiveExceptions API 600 would not return a data set describing the aforementioned given exception detail record, even if it were the case that it had not been previously communicated to the system 338. The use of a status field in this way permits certain types of exceptions to be “flagged” for internal inspection by representatives of the payment processor prior to the exception detail record being communicated to the system 338. According to some embodiments, simple inclusion in the Phone Pay Exception Detail table 330 (or VAN Exception Detail table 328) is sufficient for an exception detail record to be determined to be eligible for return via endpoint 600.

Previously, it was mentioned that the data in region 500 is the same as that contained in a bank item. In other words, the information of region 500 was initially presented to the payment processor via an item within a bank file 306 or 310; the item was read, parsed into its individual informational elements, and entered into the various fields of a record within an item detail table 316 or 318; if the record could not be matched during execution of the matching process 322, then the data was drawn from the item detail table 316 or 318, delivered to the endpoint 600, and ultimately presented via region 500 of the user interface. There is one exception to this general rule: the timely return deadline data 542. The timely return deadline data 542 indicates the day and time by which the debt settlement company 106 must inform the payment processor that the ACH or RCC instrument associated with the item is to be returned to the bank that initiated it (such as would be the case if the instrument were the product of fraud or simply initiated in error). Recall: if the payment processor is tardy in requesting that an item be returned to the bank that initiated it, the return will be deemed “late” by the processor's bank 308 or 312, and ultimately this may cause business disruption for the creditor that instructed its bank to initiate the returned payment instrument. (Herein, when a bank item is said to be returned, it is understood as a simple way of stating that the payment instrument referred to by the item is returned to the bank that initiated such instrument, thereby resulting in a return of funds to the disbursement account to which the instrument was directed.) The timely return deadline 542 is not contained in a bank item. Rather, it is a calculated value based upon certain attributes of the item, combined with knowledge of certain policies of the particular bank maintaining the disbursement account to which the instrument described by the item was directed. For a given unmatched bank item (exception), its timely return deadline may be calculated on the basis of: (1) whether the item originates from a bank file 306 associated with a VAN disbursement account (i.e., whether the item is a VAN item), or originates from a bank file 310 associated with a phone pay disbursement account (i.e., whether the item is a phone pay item); (2) whether the item describes an ACH instrument or an RCC instrument; (3) the particular bank from which the bank file 306 or 310 that was the source of the item originated; (4) in the event that the item was a phone pay item, the identity of the particular bank maintaining the phone pay disbursement account to which the instrument described by the item was directed; and (5) the date of occurrence of an “anchor” event, which is the particular event that a given bank uses to open the timeframe during which a return instruction for a given instrument may be timely delivered (example: an anchor event for a given instrument may be the act of settling the instrument or transcribing the instrument, etc.).

According to some embodiments, the time of day of the timely return deadline is determined based on a combination of: whether the item is a VAN item or a phone pay item; whether the item describes an ACH instrument or an RCC instrument; and the particular bank from which the bank file 306 or 310 that was the source of the item originated. (Example: if the item is a VAN item, and if it describes an ACH instrument, and if the bank file originated from Bank1, then the timely return deadline has a time of day of 4:45 pm Central Time; if the item is a VAN item, and if it describes an RCC instrument, and if the bank file originated from Bank1, then the timely return deadline has a time of day of 2:45 pm Central Time; and so on). In addition to determining the time of day of the timely return deadline, the actual date of the deadline must be determined, as well. According to some embodiments, the date of the deadline is determined by adding a quantity of business days (determined by bank policy) to the aforementioned date of the anchor event (also determined by bank policy). (Example: if the item is a phone pay item, and if it describes an RCC instrument, and if the bank file originated from Bank1, then the timely return deadline has a date equal to the date on which the RCC was paid, i.e., the date of the anchor event, plus one business day, i.e., the date following the date of the anchor event; if the item is a VAN item, then the timely return deadline has a date equal to the date on which the bank file 306 containing the item was created, i.e., the date of the anchor event, plus one business day, i.e., the date following the date of the anchor event; and so on). The calculations of the various timely return deadlines of each item may be performed, for example, in a database view, and the various timely return deadlines may be returned in the aforementioned data sets describing an exception via the NextActiveExceptions endpoint 600.

The method 700 of FIG. 7 pertained to populating the data store of the system 338 with exception data so that the data store could be drawn upon to populate the user interfaces of FIG. 5A or 5B (or any other such user interface) with exception data. In the wake of populating the data store with data, the user to whom the user interface is presented may select filter criteria 506, 508 and 510 in order to determine which particular exceptions to view and otherwise operate upon. For example, the user may select the particular debt settlement company 506 to which the exception pertains (some debt settlement providers 104 operate under several brands, meaning that exceptions related to all such brands are directed to the same system 338; the user may select exceptions based upon which particular debt settlement company brand to which they pertain), exception type 508, and date of the exception 510. The criteria are used as query criteria to query the data store for those particular exceptions that meet the criteria selected by the user.

According to some embodiments, subject to filter criteria 506, 508 and 510, selected by the user, exceptions are presented via the user interface in the order in which they were returned via the NextActiveExceptions endpoint 600. This means that the NextActiveExceptions method or function 600 may determine the order of presentation of the exceptions to the representatives of the debt settlement company 106 by virtue of determining the order in which it populates the list or array of data sets returned by it. According to some embodiments, the NextActiveExceptions method or function 600 prioritizes the presentation of exceptions via user interfaces in an order determined by its calculation of timely return deadlines: those particular unmatched items having the earliest or soonest arriving deadlines are prioritized, while those particular unmatched items having later deadlines are progressively deprioritized. For example, according to some embodiments, the NextActiveExceptions method or function 600 is structured to place data sets corresponding to unmatched items with earliest timely return deadlines in a prioritized rank of its returned list or array (such as at the “top” of the array or at a location indicated by an index of 0 or a relatively small index relative to the size of the array), while those with later deadlines are located progressively toward the “bottom” of the list or array (i.e., the list or array is rank-ordered by deadline). According to some embodiments, within a cohort of unmatched items having identical timely return deadlines, the cohort is prioritized in terms of transaction size, so that items associated with larger payment amounts are prioritized more highly than those with lesser size (the cohort is rank-ordered by transaction amount). According to some embodiments, within a cohort of unmatched items having identical timely return deadlines, the cohort is prioritized in terms of creditor 106 sensitivity to late returns, so that those items associated with the most sensitive creditors 106 are prioritized more highly than those associated with less sensitive creditors 106 (the cohort is rank-ordered by creditor 106 sensitivity). The net effect of the operation of the NextActiveExceptions API 600 combined with the previously described operations of the system 338 and user interfaces, such as those of FIGS. 5A and 5B, is that representatives of the debt settlement company can inspect and evaluate exceptions as they become available, and can do so in an order determined by early return deadline so that they are prioritizing work that is required to be completed urgently. Moreover, the system 338 permits the exceptions to be disseminated amongst representative automatically, without management or other human effort required to assign exceptions to a representative. This is a point of efficiency.

Returning discussion again to FIGS. 5A and 5B, one can see that the user interface contains a region 504 in which the user can present instructions to the payment processor by which the processor may attempt to resolve the exception that is presented via the user interface. The region contains a drop-down menu 532 from which the user may select a response code, which is an instruction to the payment processor conveying steps the payment processor should take in order respond to the exception. According to some embodiments, the entries in the menu 532 are determined by the exception type 514 of the particular exception being presented in regions 500 and 502.

Consider, for example, a situation in which the particular exception presented in regions 500 and 502 had an exception type of “Creditor Mismatch.” A “Creditor Mismatch” exception type means that, not only was underlying bank item unmatched by the matching process 322, but the particular payment transaction record to which the item was strongly matched did not share the same payee name and thus was not eligible to be actually matched to the bank item by the matching process 414. Further consider that the two following reasons could account for such a situation: (1) the strongly matched payment transaction record properly contains the name of the creditor to whom the payment should have been made at the time the scheduled payment was entered into the payment processing platform 300, but by the time of the effective date of the scheduled payment, the debt had been sold to a collection agency, and the RCC or ACH by which the payment was effectuated contained the name of the collection agency, as opposed to the name of the creditor (thus, the payee name of the payment transaction record, which contains the creditor, and the payee name of the bank item, which contains the debt collector, do not match); or (2) the strongly matched payment transaction record does not, in fact, match the underlying bank item—the reason the bank item was unmatched was because the scheduled payment (saved as a payment transaction record) was accidentally never entered into the platform 300 in the first place. In the context of this situation several possible sorts of solutions exist; (1) in the event that the strong match was correct, and the mismatch between payee names relates to the fact that one name refers to the original creditor while the other name refers to the debt collector, the representative of the debt settlement company 104 may instruct the payment processor declare the strongly matched payment transaction record to be an actual match to the bank item—this instruction may be given a response code of “ProcessPmt”; (2) in the event that the strong match was incorrect, then it may be the case that the bank item corresponds to a client 102 payment that should have been scheduled in the platform 300 but never, in fact, was, and to rectify this issue the representative may instruct the payment processor to add a scheduled payment that matches the bank item in question—this instruction may be given a response code of “AddPmt”; (3) in the event that the situation is identical to the preceding example, the debt settlement company 104 representative may add the matching scheduled payment himself or herself, instead of instructing the payment processor to do so—to indicate that this was done, the representative may select a response code of “PmtLoaded”; (4) in the event that the strong match was incorrect and the actual state of affairs is that the instrument underlying the bank item never should have been initiated at all, the representative would instruct the payment processor to return the bank item in order to receive a refund of the funds that were improperly pulled—this instruction may be given a response code of “Return”; and (5) in the event that the underlying scenario and solution are completely unexpected, the representative may need to enter instructions explaining the situation and the solution—the representative may do this via input field 536, while selecting a response code of “Other.” Thus, in the context of a “Creditor Mismatch,” the drop-down menu 532 would include each of the above-stated response types, i.e., “ProcessPmt,” “AddPmt,” “PmtLoaded,” “Return,” and “Other.” In the context of presenting an exception with a different exception type, the drop-down menu 532 would contain a different set of response codes, so as to present response options that are appropriate to remedy an exception of the aforementioned different type. Thus, the set of response codes in the drop-down menu 532 are determined by the response type of the particular exception being displayed in regions 500 and 502.

According to some embodiments, the system 338 may call the API layer 334, such as directing an API call to the ResponseTypesGet endpoint 608. The ResponseTypesGet endpoint 608 responds by returning a list of each of the exception types in association with their potential response codes. For example, conceptually, the response may be structured as:

```
{ (exception type₁, response codeₐ, description of response codeₐ),
  (exception type₁, response code_{b}, description of response code_{b}),
  (exception type₂, response code_{c}, description of response code_{c}),
  (exception type₂, response code_{b}, description of response code_{b}),
  (exception type₂, response code_{d}, description of response code_{d}),
  (exception type₃, response code_{c}, description of response code_{c}),
  .... }
```

According to these embodiments, the response from the ResponseTypesGet endpoint 608 is stored in a database table and a query is formed for those particular records having the exception type of the particular exception being displayed in regions 500 and 502, and the response codes of the various returned records is used to populate the options within the drop-down menu 532.

The consequences of populating the elements of the drop-down menu 532 with response codes determined by the exception type of the particular exception being displayed in regions 500 and 502 are: (1) because the instructions are generally articulated with a code, the actions to be taken by the payment processor to resolve an exception are unambiguous; and (2) because the response codes are mated to exception types, the choices present in the menu 532 actually result in the exception being resolved, as opposed to the personnel of the payment processor following instructions given by the debt settlement company 104, only to discover that the instructions do not result in the exception coming to resolution.

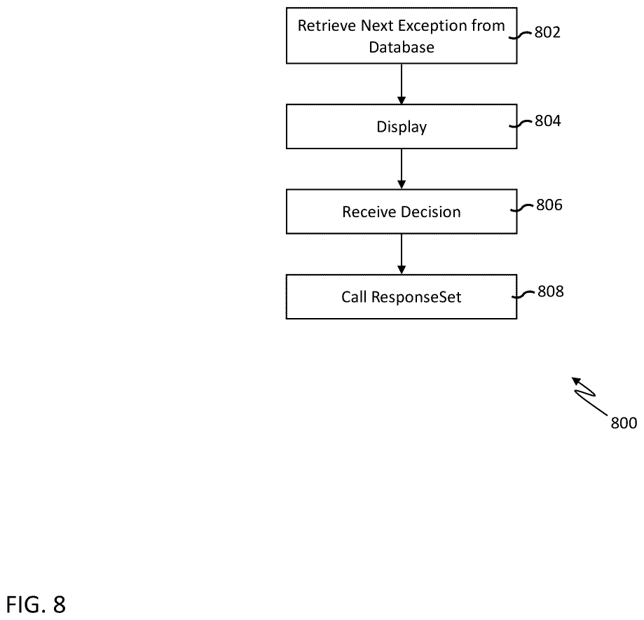

According to some embodiments, in use, the system 338 performs the acts of method 800, depicted in FIG. 8. The method begins with operation 802, during which the data set describing the next exception is retrieved from the data store of the system 338, subject to the filter requirements 506, 508 and 510. The data set is then used, in operation 804, to populate regions 500 and 502 of the user interface. (According to some embodiments, the system 338 may call AckActiveExceptions 602 either prior to or following population of the user interface to prevent displayed exceptions from being returned redundantly). The user responds to presentation of the data by providing the appropriate instructions related to how to resolve the exception via region 504, and such inputs of the user are received in operation 806. Finally, in operation 808, the API layer 334 is called with the aforementioned user inputs, such as by calling the ResponseSet endpoint 606. The API call includes in its payload: the unique identifier of the exception displayed via the user interface; the selected response code from menu 332; the payment identifier identifying the particular payment transaction record (if any) to which the actions indicated by the response code should be applied; and any instruction string entered in the notes field 536. The platform 300 responds by storing this information in data store 314, so that representatives of the payment processor can carry out the remedial steps indicated by the information, in order to resolve the exception. For example, the ResponseSet function or method 606 may populate fields of the unified exception records in table 332 with the response code or response type, the response note and the identifier of the payment transaction record entered in field 534, and may further record a timestamp indicating the day and time that such response was returned via the endpoint 606. According to some embodiments, after performance of such remedial steps, the bank item is once again subjected to the matching process 334, with the expected outcome being that the bank item will be actually matched by the process 334 in the wake of the remedial steps having been performed (and the underlying exception detail record will be assigned a status indicating that the item to which it refers has been matched to a payment transaction record—example: “Matched” may be stored in the “status” field).

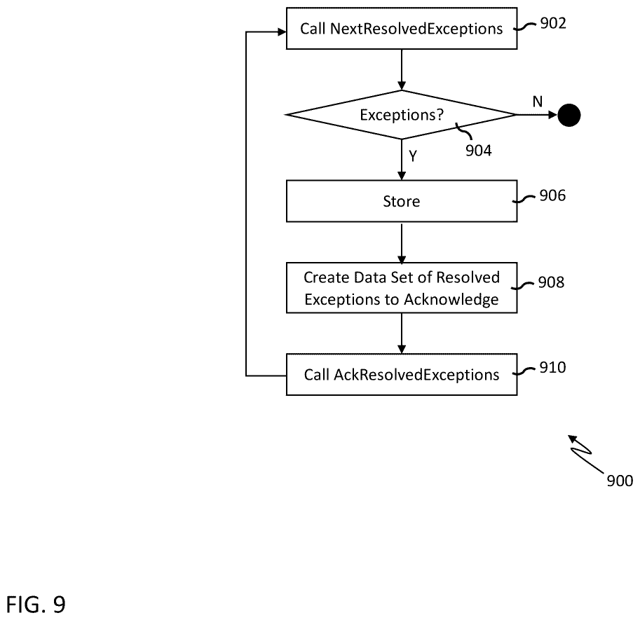

According to some embodiments, the data store of the system 338 locally stores information pertaining to resolved exceptions. For example, this may be done so that records of resolved exceptions can be reviewed to ensure that they were resolved according to the instructions provided by the debt settlement company 104. To permit resolved exception data to be stored locally at the data store, a method 900 (FIG. 9) parallel to the method 700 (FIG. 7) pertaining to obtaining data relating to active exceptions may be executed by the system 338.

The method 900 of FIG. 9 begins in operation 902 by the system 338 calling the NextResolvedExceptions endpoint 610 within the API layer 334 of the payment processor's computing platform 300. NextResolvedExceptions 610 responds by returning information pertaining to those particular resolved exceptions (i.e., exception records associated with a bank item that is no longer unmatched to a payment transaction record) that have not previously been communicated to the system 338 via the endpoint 610.

NextResolvedExceptions 610 may identify those particular exceptions that have been previously communicated to the system 338 via an acknowledgement system parallel to that used in connection with NextActiveExceptions 600—except that the particular acknowledgement memorializing that the system 338 has properly received the resolved exception may be stored in a separate field in the exception record (example: the date of acknowledgement of a resolved exception may be stored in a “Res_Ack_Date” field within the exception record, as opposed to an “Ack_Date” field). According to some embodiments, in response to invocation, NextResolvedExceptions 610 may return the particular data items that were returned in response to a call to the NextActiveExceptions API 600.

In the wake of having called NextResolvedExceptions 610 and having received a response (operation 902), the response is examined to determine whether it, in fact, contains any data sets describing resolved exceptions. If not, the method 900 is terminate. On the other hand, if the response does, in fact, contains at least one data set describing a resolved exception, then control is passed to operation 906, wherein the at least one data set is stored in a data store, such as a data store local to the system 338. For example, each such data set may be stored as a record or plurality of associated record in a table (or more than one table) of a database, so that each such record or set of associated records stores data pertaining to a resolved exception.

After having saved the resolved exception data (operation 906), a data set identifying each of the resolved exceptions that were properly read is created (operation 908). This operation 908 is parallel to that of operation 722 in connection with the NextActiveExceptions endpoint 600, and for the sake of brevity is not redescribed here. After creating the aforementioned data set, the endpoint layer 334 is called using the data set in order to acknowledge the properly received resolved exceptions (operation 910), such as by calling the AckResolvedExceptions endpoint 612. This operation 910 and the response of the endpoint 612 to such invocation are parallel to that which was previously described with reference to operation 724, and for the sake of brevity such matters are not redescribed here.

As was mentioned previously, it is not necessary that the system 300 maintain separate tables 316 and 318 for storage of VAN items (table 316) and phone pay items (table 318). Moreover, it is not necessary that the system maintain separate exception tables for VAN exception details (table 328) and phone pay exception details (table 330). According to some embodiments, VAN and phone pay items are stored in the same table 1000 (FIG. 10), and exceptions pertaining to such items are stored in a single table 1002. Thus, according to these embodiments, the exceptions table 1000 contains all of the exception detail informational elements, and also contains the informational elements exceptions “unifying” table 332, such as the response code or response note entered by the user via the user interface (such as that of FIG. 5A or 5B), as well as the date of acknowledgement of having read the exception record while it was in an active state and the date of acknowledgement of having read the exception after it had entered a resolved state. Thus, reading and writing operations that previously would have spanned tables 328, 330 and 332 with the aid references, such as keys, are now performed upon table 1002. Similarly, reading and writing operations that were previously performed with respect to both tables 316 and 318 (example: storing operations 406 and 412 and matching operation 414) are now performed against table 1000. The unification of such tables promotes efficiency, and is therefore desirable.

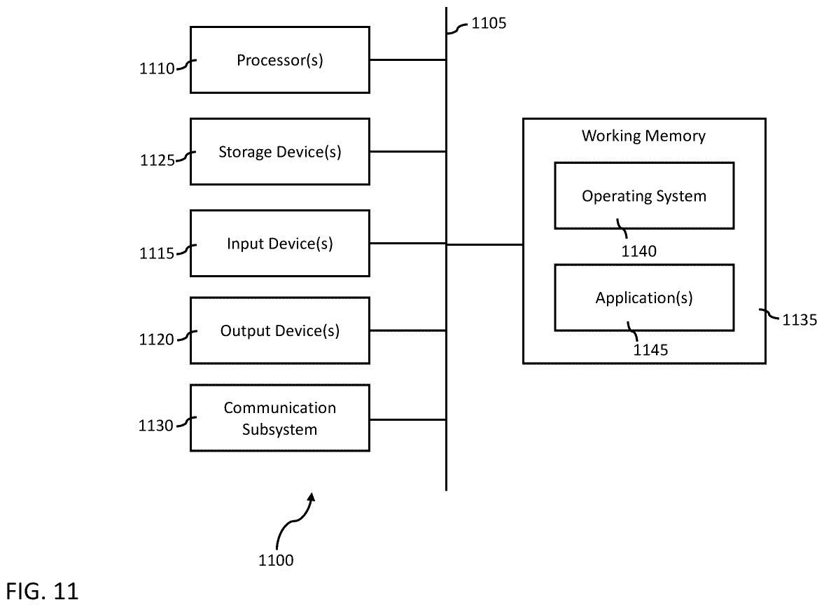

To perform the actions of the payment processing platform 100, 200, or 300, host the websites 108 and 124, run web browsers to permit interaction with the websites 108 and 124, perform the operations of the system 338, execute any of the methods or schemes herein and/or embody any of the other previously mentioned computing devices, a computer or server system as illustrated in FIG. 11 may be used. FIG. 11 depicts a schematic illustration of one embodiment of a computer system 1100 that can perform the methods provided by various other embodiments, as described herein, and/or can function as the host computer system, a server system, a laptop, tablet, smartphone, a mobile device, and/or a computer system. It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner.

The computer system 1100 is shown comprising hardware elements that can be electrically coupled via a bus 1105 (or may otherwise be in communication, as appropriate). The hardware elements may include one or more processors 1110, including without limitation one or more general-purpose processors and/or one or more special-purpose processors (such as digital signal processing chips, graphics acceleration processors, and/or the like); one or more input devices 1115, which can include without limitation a mouse, a keyboard, touchscreen and/or the like; and one or more output devices 1120, which can include without limitation a display device, a printer and/or the like.

The computer system 1100 may further include (and/or be in communication with) one or more storage devices 1125, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1100 may also include a communications subsystem 1130, which can include without limitation a modem, a network card (wireless or wired), an infrared communication device, a wireless communication device and/or chipset (such as a BLUETOOTH™ device, an 802.11 device, a WiFi device, a WiMax device, cellular communication facilities, etc.), and/or the like. The communications subsystem 1130 may permit data to be exchanged with a network (such as the network described below, to name one example), other computer systems, and/or any other devices described herein. In many embodiments, the computer system 1100 will further comprise a working memory 1135, which can include a RAM or ROM device, as described above.

The computer system 1100 also can comprise software elements, shown as being currently located within the working memory 1135, including an operating system 1140, device drivers, executable libraries, and/or other code, such as one or more application programs 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1125 described above. In some cases, the storage medium might be incorporated within a computer system, such as the system 1100. In other embodiments, the storage medium might be separate from a computer system (e.g., a removable medium, such as a compact disc), and or provided in an installation package, such that the storage medium can be used to program, configure and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1100) to perform methods in accordance with various embodiments of the invention. According to a set of embodiments, some or all of the procedures of such methods are performed by the computer system 1100 in response to processor 1110 executing one or more sequences of one or more instructions (which might be incorporated into the operating system 1140 and/or other code, such as an application program 1145) contained in the working memory 1135. Such instructions may be read into the working memory 1135 from another computer-readable medium, such as one or more of the storage device(s) 1125. Merely by way of example, execution of the sequences of instructions contained in the working memory 1135 might cause the processor or processors 1110 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1100, various computer-readable media might be involved in providing instructions/code to the processor or processors 1110 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1125. Volatile media include, without limitation, dynamic memory, such as the working memory 1135. Transmission media include, without limitation, coaxial cables, copper wire and fiber optics, including the wires that comprise the bus 1105, as well as the various components of the communication subsystem 1130 (and/or the media by which the communications subsystem 1130 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor or processors 1110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1100. These signals, which might be in the form of electromagnetic signals, acoustic signals, optical signals and/or the like, are all examples of carrier waves on which instructions can be encoded, in accordance with various embodiments of the invention.

The communications subsystem 1130 (and/or components thereof) generally will receive the signals, and the bus 1105 then might carry the signals (and/or the data, instructions, etc. carried by the signals) to the working memory 1135, from which the processor(s) 1105 retrieves and executes the instructions. The instructions received by the working memory 1135 may optionally be stored on a storage device 1125 either before or after execution by the processor(s) 1110.

The various embodiments described above are provided by way of illustration only and should not be construed to limit the invention. Those skilled in the art will readily recognize various modifications and changes that may be made to the present invention without departing from the true spirit and scope of the present invention, which is set forth in the following claims.

The claimed invention is:

1. A payment system including a data store, wherein said payment system is arranged to initiate a payment process upon an effective date and to a payment recipient determined by effective date information and payment recipient information stored in a payment record that is stored in said data store, wherein said payment process includes a funds transfer step not initiated by said payment system, and wherein occurrence of said funds transfer step is recorded in an item record in said data store, said payment system comprising:
a computing device including a processing unit and a memory communicably connected with and readable by said processing unit, said memory unit containing instructions that, when executed by said processing unit, cause said processing unit to:
perform a matching process to attempt to identify an association between said payment record and said item record, wherein said matching process records an exception record in said data store, in response to a failure of said matching process to identify said association, wherein said exception record includes exception type information;
expose, via a first application interface accessible via a network, information from said item record and said exception type information from said exception record; and
receive, via a second application interface accessible via said network, a selected response code, wherein said selected response code contains information sufficient to perform operations via said payment system that result in said association being identified.

2. The payment system of claim 1, wherein said funds transfer step comprises initiation of a remotely created check by said payment recipient.

3. The payment system of claim 1, wherein said funds transfer step comprises initiation of an automated clearinghouse transaction by said payment recipient.

4. The payment system of claim 1, wherein said payment process comprises transferring funds from a funds pool to a disbursement account.

5. The payment system of claim 1, wherein said selected response code is selected from a set of candidate response codes determined by said payment system.

6. The payment system of claim 5, wherein said set of candidate response codes is determined by said payment system by associating said exception type information with said set of candidate response codes.

7. The payment system of claim 6, wherein said set of candidate response codes contains plural individual candidate response codes, and wherein each of said individual candidate response codes contains information sufficient to perform operations via said payment system resulting in said association to be identified, given said exception type information.

8. The payment system of claim 7, wherein said network is a public network.

9. The payment system of claim 8, wherein said memory unit contains further instructions that, when executed by said processing unit, cause said processing unit to:
perform said matching process so as to identify a possible association between said payment record and said item record, in response to a failure of said matching process to identify said association.

10. The payment system of claim 9, wherein information from said payment record is exposed via said first application interface, in response to said possible association between said item record and said payment record having been identified by said matching process.

11. The payment system of claim 10, wherein said first application interface comprises a plurality of application interfaces.

12. The payment system of claim 1, wherein said first application interface comprises a plurality of application interfaces.

13. A method for responding to a failure of a matching process, implemented by a payment system, to associate a payment record with an item record, wherein said payment system initiates a payment process upon an effective date and to a payment recipient determined by effective date information and payment recipient information stored in said payment record, wherein said payment process includes a funds transfer step not initiated by said payment system, and wherein occurrence of said funds transfer step is recorded in said item record, said method comprising:
performing, with said payment system, said matching process in order to attempt to identify an association between said payment record and said item record, wherein said matching process records an exception record, in response to a failure of said matching process to identify said association, wherein said exception record includes exception type information;
exposing, with said payment system and via a first application interface accessible via a network, information from said item record and said exception type information from said exception record; and
receiving, with said payment system and via a second application interface accessible via said network, a selected response code, wherein said selected response code contains information sufficient to perform operations via said payment system that result in said association being identified.

14. The method of claim 13, wherein said funds transfer step comprises initiation of a remotely created check by said payment recipient.

15. The method of claim 13, wherein said funds transfer step comprises initiation of an automated clearinghouse transaction by said payment recipient.

16. The method of claim 15, wherein said payment process comprises transferring funds from a funds pool to a disbursement account.

17. The method of claim 16, wherein said selected response code is selected from a set of candidate response codes determined by said payment system.

18. The method of claim 17, wherein said set of candidate response codes is determined by said payment system by associating said exception type information with said set of candidate response codes.

19. A method for responding to a failure of a matching process, implemented by a payment system, to associate a payment record with an item record, wherein said payment system initiates a payment process upon an effective date and to a payment recipient determined by effective date information and payment recipient information stored in said payment record, wherein said payment process includes a funds transfer step not initiated by said payment system, and wherein occurrence of said funds transfer step is recorded in said item record, said method comprising:
performing, with said payment system, said matching process in order to attempt to identify an association between said payment record and said item record, wherein said matching process records exception type information, in response to a failure of said matching process to identify said association;
exposing, with said payment system and via a first application interface accessible via a network, information from said item record and said exception type information; and
receiving, with said payment system and via a second application interface accessible via said network, a selected response code, wherein said selected response code contains information sufficient to perform operations via said payment system that result in said association being identified.

20. The method of claim 19, wherein said payment process comprises creating a payment history record corresponding to said payment record.
